(19) United States
(12) Patent Application Publication
(10) Pub. No.: US 2026/0216692 A1
(43) Pub. Date: Jul. 30, 2026

(54) CARBONACEOUS MATERIALS FOR USE IN METHODS OF MANUFACTURING ACTIVATED CARBON

(71) Applicant: Arq IP Limited, London (GB)

(72) Inventors: Micala Mitchek, Denver, CO (US); Lingyan Song, Englewood, CO (US); Mowen Li, Highlands Ranch, CO (US); Joseph M. Wong, Castle Pines, CO (US)

(21) Appl. No.: 19/630,333

(22) Filed: Mar. 26, 2026

Related U.S. Application Data
(63) Continuation-in-part of application No. 19/402,931, filed on Nov. 26, 2025.
Application No. 19/402,931 is a continuation-in-part of application No. 18/977,529, filed on Dec. 11, 2024.
Application No. 18/977,529 is a continuation-in-part of application No. 18/574,432, filed on Jun. 29, 2022.
(60) Provisional application No. 63/608,695, filed on Dec. 11, 2023.
(60) Provisional application No. 63/615,687, filed on Dec. 28, 2023.
(60) Provisional application No. 63/726,181, filed on Nov. 27, 2024.
(60) Provisional application No. 63/778,181, filed on Mar. 26, 2025.
(60) Provisional application No. 63/849,363, filed on Jul. 23, 2025.
(60) Provisional application No. 63/876,764, filed on Sep. 5, 2025.

(51) Int. Cl. B01J 20/20; B01J 20/28; C02F 1/28; C02F 101/34; C02F 101/36

(52) U.S. Cl. CPC B01J 20/20; B01J 20/28011; B01J 20/28019; B01J 20/2803; B01J 20/28066; B01J 20/28071; B01J 20/28073; B01J 20/2808; B01J 20/28083; C02F 1/283; C02F 2101/34; C02F 2101/36; C02F 2101/40

(57) ABSTRACT

A sorbent composition comprising primarily activated carbon with an apparent density of at least about 0.30 g/cc, wherein the sorbent composition comprises small mesopores, wherein the small mesopores have a pore size ranging from about 20 Å to about 150 Å, wherein a volume of small mesopores is at least about 0.10 cc/g, wherein the sorbent composition comprises micropores, wherein the micropores have a pore size of less than about 20 Å, wherein a volume of micropores is at least about 0.35 cc/g, and wherein the sorbent comprises from about 10 vol. % to about 35 vol. % solid activated carbon.

### CROSS REFERENCES

This application claims priority to US Provisional Application Ser. Nos. 63/778,181, filed Mar. 26, 2025, and 63/876,764, filed Sep. 5, 2025, each entitled “ASSEMBLING AND DENSIFYING ACTIVATED CARBON RAW MATERIALS FOR GRANULAR ACTIVATED CARBON WITH ENHANCED ADSORPTIVE RATES” and is incorporated herein by reference in their entirety, and this application is a continuation-in-part to U.S. patent application Ser. No. 19/402,931, which claims priority to U.S. Provisional Application Ser. No. 63/726,181, filed Nov. 27, 2024, and 63/849,363, filed Jul. 23, 2025, and which is a continuation-in-part to U.S. patent application Ser. No. 18/977,529, filed Dec. 11, 2024, which is a continuation-in-part to U.S. patent application Ser. No. 18/574,432, which is a 371 of International Application PCT/US2022/035480, filed Jun. 29, 2022, which claims priority to U.S. Provisional Application Ser. No. 63/216,641, filed on Jun. 30, 2021, each of which are incorporated herein by reference in their entirety.

### FIELD

The disclosure relates generally to shaped sorbents and particularly to shaped activated carbon.

### BACKGROUND OF THE DISCLOSURE

Activated carbon-based sorbent materials, such as those made from lignite coal, Powder River Basin (PRB) coal, bituminous coal, coconut shells, wood, nutshells, cellulose or any other carbon-containing material, are used in powdered (i.e., less than about 177 micron particle size), granular (i.e., greater than about 177 micron particle size) and other sizes and shapes for a host of gas and liquid-phase contaminant removal applications. The activated carbon-based sorbent materials are typically manufactured by heating the raw organic materials that are high in carbon in the absence of oxygen and the presence of steam. This process increases the surface area of the carbon, making the sorbent material highly porous and suitable for removing contaminants from liquids, gases, or solids.

The material and form of the activated carbon deployed is highly dependent on the end-use application. In one example for coal-fired power plant flue gas treatment to remove mercury, “small” particle sized powder activated carbon (PAC) is injected into the flue gas and is highly dispersed to contact, convert and capture the mercury. In another example for taste and odor contaminant removal from municipal potable water purification, PAC is dispersed in the raw water and in its highly dispersed form is very effective in removing the contaminants. In yet another example, large-particle granular activated carbons (GAC) are used predominantly in applications employing a stream of contaminated gas or liquid flowing through a column or vessel of packed GAC. In this example, the “large” size GAC particles allow the stream to flow through the packed carbon bed at high flowrates, with low pressure drop and high contact with the contaminant. The GAC not only needs to have the adsorptive (e.g., physiochemical) properties, but it also needs to have sufficient mechanical properties, particularly relating to high hardness and low dustiness for efficient contaminant removal and for proper functioning in process equipment.

A property that gives an indication of the hardness and integrity of a GAC is Ball Pan Hardness (BPH). Particularly, a BPH value indicates the degradation resistance of a GAC. A GAC with a BPH value greater than about 60% is typically considered to have sufficient degradation resistance for use in contaminant removal. As such, GACs produced commercially are made traditionally from dense starting materials, such as bituminous coal, reagglomerated bituminous coal, coconut, etc. that result in hard (e.g., strong) particles that maintain their size and shape during use and typically result in a BPH about 60-95%.

Activation of low-rank coal, sub-bituminous coal or cellulosic material (e.g., wood, fiber, etc.) such as by direct steam, on the other hand, may also be used to produce a GAC with desired adsorptive properties, such as properties beneficial for sequestering a particular target contaminant. In some cases, it may be cheaper to manufacture a GAC from low-rank coal, sub-bituminous coal or cellulosic material. A GAC manufactured from the low-rank coal, sub-bituminous coal or cellulosic material, however, may not exhibit desired mechanical hardness (i.e., BPH less than about 50%) and/or achieve the low dust levels necessary for market application. GAC manufactured from the low-rank coal, sub-bituminous coal or cellulosic material may be considerably more dusty than a GAC manufactured from denser starting materials, such as the bituminous coal, reagglomerated bituminous coal, coconut, etc. (e.g., a “dusty” GAC is characterized by carbon particles passing a 325 mesh screen of greater than about 0.4 wt %).

Removal of contaminants is an increasingly challenging issue for different media, such as air and water (e.g., groundwater, drinking water, wastewater, etc.) and is subject to increasingly stringent regulations. The present disclosure is directed to increasing activated carbon contaminant adsorption rates and/or contaminant mass diffusion rates to adsorption sites through the creation of favorable surface and pore structures. These favorable activated carbon properties may be formed using specific activation conditions (contact time, temperature, steam) and/or using additives, such as, but not limited to, carboxymethyl cellulose (CMC), starches, fatty acids, lignosulfonates and other organic additives and polymers, which can degrade or volatilize during heat treatment of the re-agglomerated carbon particulates and leave void space or holes. These void spaces or holes may facilitate activation gases, such as steam, to diffuse into the interior of the granule during the activation process, thereby enhancing the transport pore and/or small mesopore formation.

Such sacrificial additives can provide increased transport small mesopore volume, which can increase diffusion rates of contaminants within the activated carbon particle, and/or intragranular channels. Sacrificial additives may also serve as green strength binders. Stated differently, such sacrificial additives can provide increased transport pore volume and interconnecting pore tunnels that increase porosity and/or permeability of the activated carbon surface and increase granule hardness as well as decrease dustiness. In some formulations, a primary coal fine particle size of no more than about 10 μm is used in the carbonaceous feed material causing the particles to be fused together with binders to form small grains, facilitating the transportation of contaminants to contact with the carbon media after activation. In embodiments, the primary coal fine particle size used has a particle size distribution D90 of 90 μm and a particle size distribution D50 of about 50 μm. The formulations and processes disclosed herein can result in a lower tortuosity of the contaminant in pores as modeled by a pore and surface diffusion model.

The present disclosure can produce a GAC product with improved properties including, but not limited to, improved charring/coking and activation ability, faster adsorption kinetics, reduced pressure drop through a vessel, better reactivation integrity, lower dust, and greater adsorption performance for certain contaminants. Also, the present disclosure provides a process of increasing contaminant adsorption rates through additives that serve as green strength binders and/or as sacrificial component which degrade and/or volatilize during charring and activation to facilitate the creation of the enhanced transport small mesopores, diffusional channels, porosity, and optionally enhanced intragranular channels. The present disclosure provides an enhanced activation process that can increase the abundance of mesopores and large diffusion pores/channels in addition to the pores developed in the activation process. The present disclosure provides for a spherical shaped granular activated carbon with micro grain size structure and tuned pore size distribution to accelerate the transportation and sequestration of contaminants into the carbon pores with enhanced transport small mesopores.

### SUMMARY

These and other needs are addressed by the various aspects, embodiments, and/or configurations of the present disclosure.

In accordance with aspects of the present disclosure, a sorbent composition is provided for that includes primarily activated carbon with an apparent density of at least about 0.30 g/cc, wherein the sorbent composition comprises small mesopores, wherein the small mesopores have a pore size ranging from about 20 Å to about 150 Å, wherein a volume of small mesopores is at least about 0.10 cc/g, wherein the sorbent composition comprises micropores, wherein the micropores have a pore size of less than about 20 Å, wherein a volume of micropores is at least about 0.35 cc/g, and wherein the sorbent comprises from about 10 vol. % to about 35 vol. % solid activated carbon.

In accordance with aspects of the present disclosure, a method is provided for which comprises treating a contaminated medium with a sorbent composition comprising greater than about 90 wt % bituminous coal, less than about 0.5 wt % green strength binder, and less than about 2 wt % moisture, wherein the sorbent composition comprises sequestration pores, wherein the sequestration pores have a pore size of about 1 to about 2 times the molecular diameter of a target contaminant, wherein the sorbent composition has an apparent density of at least about 0.30 g/cc, and wherein the sequestration pore volume is at least about 0.15 cc/g.

The present disclosure can provide a number of advantages depending on the particular aspect, embodiment, and/or configuration. Granular activated carbons (GACs) produced commercially are made from dense starting materials like bituminous coal, re-agglomerated coal, coconut, etc. that give very strong and hard particles that maintain their size and shape in use. However, most of them are in irregular shape, having a lower sphericity and aspect ratio. The process described in this disclosure can create a GAC product with improved properties including improved charring/coking and activation ability, faster adsorption kinetics (e.g., speed and selectivity of adsorption), reduced pressure drop through a vessel due to a relatively uniform particle size distribution, better reactivation integrity, lower dust, and faster and greater adsorption performance for certain contaminants. The substantially uniform, spherically shaped, high activity activated carbon can have a unique composition for use in contaminant removal from soil, liquid and gas streams. Due to the highly pure nature of the raw material, the composition can provide a reduced leaching of trace metals, improved adsorption kinetics (rate and selectivity), and improved operational efficiencies, such as higher flowrates, reduced energy consumption, low dustiness and fines creation during handling, improved adsorption capacity for contaminants including drinking water taste and odor compounds, ground and drinking water PFAS, acid gases and VOCs in industrial and biogas applications. The high hardness and high sphericity of the highly activated granular activated carbon of the present disclosure can have a reduced pressure drop (e.g., lower energy consumption and higher flow rates) and abrasion during handling, and a tuned surface and pore properties can prevent leaching of residual constituents (particularly for purified coal raw material) while adsorbing target contaminants from municipal water, groundwater, soils, and sediments. Such spherically shaped granular activated carbon with a micro grain size structure and tuned pore size distribution can accelerate the transportation and sequestration of contaminants into the carbon pores. Specifically, the porosity distribution and microstructure and/or surface charge and hydrophobicity can be tuned for specific contaminants. The increased integrity of the spherically shaped granular activated carbon material can endure multiple cycles of reactivation. This is believed to be due to the high strength properties of the granular activated carbon material from coking/plasticization coupled with a spherical shape without corners that abrade into dust.

These and other advantages will be apparent from the disclosure.

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated. As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on. “At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Absorption” is the incorporation of a substance in one state into another of a different state (e.g. liquids being absorbed by a solid or gases being absorbed by a liquid). Absorption is a physical or chemical phenomenon or a process in which atoms, molecules, or ions enter some bulk phase-gas, liquid or solid material. This is a different process from adsorption, since molecules undergoing absorption are taken up by the volume, not by the surface (as in the case for adsorption).

“Activated carbon” or “AC” refers to a predominately amorphous carbon that has been treated with steam and heat to exhibit strong affinity for adsorbing target contaminants.

“Adsorption” is the adhesion of atoms, ions, biomolecules, or molecules of gas, liquid, or dissolved solids to a surface. This process creates a film of the adsorbate (the molecules or atoms being accumulated) on the surface of the adsorbent. It differs from absorption, in which a fluid permeates or displaces a liquid or gas to occupy volume within a solid. Similar to surface tension, adsorption is generally a consequence of surface energy. The exact nature of the bonding depends on the details of the species involved, but the adsorption process is generally classified as physisorption (characteristic of weak van der Waals forces) or chemisorption (characteristic of covalent bonding). It may also occur due to electrostatic attraction.

“Agglomerates” are particle composites formed by smaller particles bonded together, typically by an organic, inorganic, or compound binder, to form larger and stable agglomerates. Agglomeration can occur in a variety of ways, including mechanical, thermal, or chemical methods. An agglomerate of the present disclosure may refer to native coal particles. A re-agglomerate of the present disclosure may refer to or may be referred to as a “granule” or “agglomerate” and may include one or more binding agents.

“Ash” refers to the inorganic—e.g. non-hydrocarbon—mineral component found within most types of fossil fuel, especially that found in coal. Ash is comprised within the solid residue that remains following combustion of coal, sometimes referred to as fly ash. As the source and type of coal is highly variable, so is the composition and chemistry of the ash. However, typical ash content includes several oxides, such as silicon dioxide, calcium oxide, iron (III) oxide and aluminum oxide. Depending on its source, coal may further include in trace amounts one or more substances that may be comprised within the subsequent ash, such as arsenic, beryllium, boron, cadmium, chromium, cobalt, lead, manganese, mercury, molybdenum, selenium, strontium, thallium, and vanadium.

“Binding agent” refers to a material or substance that holds other materials together mechanically and/or chemically to form a cohesive whole and may otherwise be referred to as a “binder”, “binder material,” “bonding agent,” “adhesive,” “adhesion agent,” “connection agent,” “coupling agent,” and “fixing agent.”

The term “carbon-rich” refers to a material comprising at least about 50 wt %, more commonly at least about 55 wt %, more commonly at least about 60 wt %, more commonly at least about 65 wt %, more commonly at least about 70 wt %, more commonly at least about 75 wt %, more commonly at least about 80 wt %, more commonly at least about 85 wt %, and even more commonly at least about 90 wt % (wet or dry basis) carbon or carbon-containing compounds.

“Coal” is used herein to denote readily combustible sedimentary mineral-derived solid hydrocarbonaceous material including, but not limited to, hard coal, such as anthracite; bituminous coal; sub-bituminous coal; and brown coal including lignite (as defined in ISO 11760:2005). “Native” or “feedstock” coal refers coal that has not been subjected to extensive processing and comprises a physical composition (e.g. maceral content) that is substantially unchanged from the point of extraction. In contrast, the terms “coal-derived product”, “coal replacement product” and “purified coal compositions” are used herein to refer to various coals which have been subjected to one or more processes that lead to a change in physical and/or chemical compositions of the coal such that it is substantially changed from the point of extraction—i.e., the natural state.

“Contaminants” as used herein, refers to target contaminants found in selected composition to be treated. Compositions to be treated may include gases such as flue gases, soil, groundwater, municipal water, wastewater, industrial water, wastewater, industrial gases, military gases, biogas, and other fluids or solids. Exemplary contaminants may include inorganic contaminants such as acid gases (including hydrogen sulfide (H₂S)), coal combustion residuals (CCRs), such as arsenic (As), cobalt (Co), lithium (Li), molybdenum (Mo), and boron (B) and volatile organic compounds, such as acetone, methyl ethyl ketone (MEK), benzene, toluene, xylene, limonene and siloxanes, organic contaminants such as (petroleum) hydrocarbons, chlorinated solvents, Per and Polyfluoroalkyl Substances (PFAS including PFOS, PFOA, and additional long and short chain PFAS), taste and odor compounds (including 2-methylisoborneo and geosmin), natural organic matter (including total and dissolved organic carbon), herbicides and pesticides (including atrazine), other micropollutants (including Candesartan, Carbamazepine, Clarithromycin, Diclofenac, Hydrochlorothiazide, Ibuprofen, Irbesartan, metoprolol, Sulfamethoxazole, Iopromide, amisulpride, azithromycin, citalopram, metformin, oxipurinol, valsartan, venlafaxine), chlorinated solvents (including tetrachloroethene, trichloroethene, dichloroethene, vinyl chloride), hydrocarbons (including total petroleum hydrocarbons, benzene, toluene, ethylbenzene, xylenes), and 1,4-Dioxane.

“Diffusion pores” refer to small mesopores of an activated carbon-comprising composition, and may otherwise be referred to transportation pores.

“Fixed carbon” refers to the remaining carbon after carbonization process and the activation process, demonstrated by: wt % Fixed carbon=100%−(% volatile matter content−% ash content−% moisture content).

“Hard raw material” refers to dense carbon-comprising materials such as bituminous coal, re-agglomerated bituminous coal, coconut, etc. and may otherwise be referred to as “hard starting material,” “hard sourcing material,” “hard feedstock,” or the like.

The term “hard sorbent composition” refers to a sorbent composition having a ball pan hardness of at least about 80%, or more typically at least about 85%, or more typically at least about 90% and/or an abrasion number of at least about 65%, or more typically at least about 70%, or more typically at least about 75%, or more typically at least about 80%.

“Intergranular channels” refer to channels that can consist of grain boundaries and/or cross grain boundaries.

“Intragranular channels” refer to channels that are within grains of a material and can transport contaminants or other molecules. Unlike intergranular channels, intragranular channels do not cross grain boundaries and are wholly contained within a grain.

The term “low ash coal” refer to native coal that has a proportion of ash-forming components that is lower when compared to other industry standard coals. Typically, a low ash native or feedstock coal will comprise less than around 12 wt % ash. The term “deashed coal”, or the related term “demineralized coal”, is used herein to refer to coal that has a reduced proportion of inorganic minerals compared to its natural native state. Ash content may be determined by proximate analysis of a coal composition as described in ASTM D3174-12 Standard Test Method for Ash in the Analysis Sample of Coal and Coke from Coal. Ash content in purified carbonaceous product derived predominantly from coal is less than 5 wt %, less than 3 wt %, less than 2 wt % and less than 1.5 wt % or even less than 1 wt % are obtained. Indeed, the present inventors have found quite unexpectedly that products having very low ash contents of around or below 1 wt % can be obtained from starting material that is as much as 50 wt % ash without having to sacrifice yield levels that render the process un-commercial.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

A “mill” refers to any facility or set of facilities that comminutes a carbonaceous material into a comminuted material having a reduced particle size. Generally, the mill includes an open or closed comminution circuit, which includes crushers or autogenous, semi-autogenous, or non-autogenous grinding mills.

“Non-coking coal,” as used herein, refers to coal that does not possess the necessary properties for coking and the production of coke such that upon heating it cannot soften, liquify and re-solidify like coking coal during the coking process. “Non-coking coal” can include bituminous coal, re-agglomerated bituminous coal, and coconut-based coal and may also be referred to as thermal coal or steam coal.

“Sequestration pores” refer to micropores of an activated carbon-comprising composition or pores that are about 1-2 times the molecular diameter of the contaminant of concern.

“Soft raw material” refers to a carbon-comprising material derived from low ranking coal (e.g., sub-bituminous coal, lignite coal, PRB coal) or “soft” starting materials such as cellulosic material (e.g., wood fiber, peat, soft nutshells), and may otherwise be referred to as “soft starting material,” “soft sourcing material,” “soft feedstock,” or the like.

A “sorbent” is a material that sorbs another substance; that is, the material has the capacity or tendency to take it up by sorption.

“Sorb” means to take up a liquid or a gas by sorption.

“Sorption” refers to adsorption and absorption, while desorption is the reverse of adsorption.

“Sphericity” is a measure of roundness of a particle and is the ratio of the surface area of a sphere with the same volume as a particle to the particle's actual surface area. A perfect sphere has a sphericity of 1.0.

“Spheronization” or “marumerization” refers to a process where small particulates are agglomerated/assembled and shaped (e.g., the output from a mixer) into typically small, rounded or spherical granules or particulates. The median, mode, and mean particulate size typically ranges from about 0.25 mm to about 10 m and more typically from about 0.4 to about 3 mm in diameter.

A “super oxidant” is a substance that is extremely effective at oxidizing other molecules, such as a superoxide or peroxygen compound (e.g., permanganate or persulfate). A superoxide is a compound that contains the superoxide ion, which has the chemical formula O⁻². Superoxide forms salts with alkali metals and alkaline earth metals. The salts sodium superoxide (NaO₂), potassium superoxide (KO₂), rubidium superoxide (RbO₂) and caesium superoxide (CsO₂) are prepared by the reaction of O₂ with the respective alkali metal.

“Transport pores” refer to small mesopores of an activated carbon-comprising composition having a pore size ranging from about 20 Å to about 150 Å or pores that are about 2-10 times the molecular diameter of the contaminant of concern.

Unless otherwise specified, the term “thermosetting” and “thermally setting” refers to the process of polymerization with irreversible hardening (i.e., curing) of a composition. Thermosetting is induced by heat or suitable radiation and may be promoted by high pressure or mixing with a catalyst.

Unless otherwise specified, the term “thermo charring”, “thermally charring”, and “charring” refers to a process to concentrate the carbon and hydrogen content in a material in preparation of activation. Charring may include dehydration, devolatilization, and removal of hetero-atoms. Charring may also be referred to as “carbonization.” In a non-limiting example, coke and charcoal are both produced by charring. In a non-limiting example, compositions like thermoset, or most solid organic compounds like wood or biological tissue, exhibit charring behavior.

Unless otherwise specified, the term “transport” refers to the movement of a contaminant through the specified material. In a non-limiting example, a contaminant can be transported through a pore of an activated carbon material. Non-limiting examples for where transport can occur can include through pores, within connecting pores, through channels on the surface of a material, through sub-surface lenticular channels, through intragranular channels, and/or through intergranular channels.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

Unless otherwise noted, all component or composition levels are in reference to the active portion of that component or composition and are exclusive of impurities, for example, residual solvents or by-products, which may be present in commercially available sources of such components or compositions.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTIONS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 shows a simplified block diagram of a system for use in manufacturing spherical granular activated carbon in accordance with an embodiment;

FIG. 2 is a plot of dimension change (%) (vertical axis) vs. time (minute) (horizontal axis) as a function of temperature (° C.) for Thermo-Mechanical Analysis (TMA) of an activated carbon sorbent of an embodiment of the present disclosure;

FIG. 3 is a plot of dimension change (%) (vertical axis) vs. time (minute) (horizontal axis) as a function of temperature (° C.) for Thermo-Mechanical Analysis (TMA) of an activated carbon sorbent of an embodiment of the present disclosure;

FIG. 4 is a plot of Cs (mg/g) (vertical axis) vs. Ceq (mg/L) (horizontal axis);

FIG. 5 is a plot of Cs (mg/g) (vertical axis) vs. Ceq (mg/L) (horizontal axis);

FIG. 6A is a plot of MIB concentration (ng/L) (vertical axis) vs. contact time (hr) (horizontal axis);

FIG. 6B is a plot of TOC concentration (ng/L) (vertical axis) vs. contact time (hr) (horizontal axis);

FIG. 7 is a plot of cumulative pore volume (cc/g) (vertical axis) vs pore width (Å) (horizontal axis);

FIG. 8 is a plot of effluent arsenic concentration (ppb. μg/L) (vertical axis) vs bed volumes of water passed (horizontal axis); and

FIG. 9 is a plot of effluent arsenic concentration (ppb. μg/L) (vertical axis) vs bed volumes of water passed (horizontal axis).

FIG. 10 is a plot of Va/cc (STP) 8-1 (vertical axis) vs relative pressure (p/p₀) (horizontal axis) to provide the full isotherms of methyl ethyl ketone (MEK) adsorption at 25° C.

FIG. 11 is a plot of Va/cc (STP) 8-1 (vertical axis) vs relative pressure (p/p₀) (horizontal axis) to full isotherms of acetone adsorption at 25° C.

FIG. 12 is a plot of Va/cc (STP) 8-1 (vertical axis) vs relative pressure (p/p₀) (horizontal axis) to full isotherms of limonene adsorption at 25° C.

FIG. 13 is a plot of quantity adsorbed (cc/g STP) (vertical axis) vs relative pressure (p/p₀) to provide full isotherms of toluene adsorption at 25° C. for AirLoq 410 VOC1.

FIG. 14 is a plot of quantity adsorbed (cc/g STP) (vertical axis) vs relative pressure (p/p₀) to provide full isotherms of toluene adsorption at 25° C. for 4×8 GAC (coconut).

FIG. 15 is a plot of pore volume (cc/g) per pore size (Å) and shows the combined pore size distribution obtained from nitrogen and mercury intrusion porosimetry.

FIG. 16 shows the volume composition of a vessel filled with granular activated carbon (GAC).

FIG. 17 shows the breakthrough percentage versus bed volumes treated for treating PFOA.

FIG. 18 shows the breakthrough percentage versus bed volumes treated for treating PFOS.

FIG. 19 shows the breakthrough percentage versus bed volumes treated for treating PFBS.

FIG. 20 shows the residual concentration (ng/L) vs contact time (hours) for the industry bituminous-based GAC, Novel GAC 1, and Novel GAC 2.

FIG. 21 shows the volume percent for void space, transport pores for PFAS, sequestration pores for PFAS, and solid carbon of three GAC with different apparent densities.

FIG. 22 is a plot of treatment to 4 ppt PFOA breakthrough (with 1,000 gallons per pound GAC) vs apparent density (g/cc) of GAC.

### DETAILED DESCRIPTION

In various embodiments, the present disclosure describes an improved composition, method and use for substantially spherically shaped, densified and uniform activated carbon sorbent for treatment of contaminants in air, soil and, surface, ground, and wastewater. The substantially uniform, spherically shaped, and high activity carbon sorbent can have a high hardness (e.g., be a hard sorbent composition), aspect ratio close to one (e.g., width/length ratio), narrow size distribution, improved physical integrity, and/or tuned surface properties (e.g., micro-grain size structure) and pore size distribution to accelerate the transportation and sequestration of contaminants into the carbon pore for enhanced adsorption capability. By tuning and homogenizing the raw material, feed preparation (e.g., assembling with a green strength binder and optionally an activation binder, shaping and densifying the raw material in a spheronizer (such as a pin mixer or other spheronizing device) into large spherical granules), and charring/coking/thermal activation profile with steam under controlled conditions when producing granular activated carbon (GAC), the final GAC product can have a high sphericity, close to 1 aspect ratio, preferred porosity, surface functionalities, and structural and adsorptive properties for removal of target contaminants in any fluid medium or soil, such as volatile organic compounds or VOCs, hydrogen sulfide, siloxane, Taste and Odor contaminants in drinking water, PFAS, acid gases, etc. The additive is particularly useful in industrial gas and biogas treatment and pre-treatment, pressure and temperature swing adsorption columns, and other treatment vessels. Optionally, additives (discussed below) may be incorporated into the carbonaceous feedstock and the activated carbon product for improved adsorption selectivity, capacity, catalytic effects, and/or reduced leaching of impurities.

The present disclosure can employ an improved set of activation conditions to make shaped, densified and uniform activated carbon that can be formed in granular activated carbon (GAC) for treatment of contaminants in air, soil and ground water. The disclosure can employ a highly purified, small particle sized bituminous based coal product as a raw material.

The sorbent can be based on (e.g., as the primary sorbent), or incorporates (e.g., as a binder), a carbonaceous material as described in U.S. patent application Ser. No. 18/977,529 and U.S. patent application Ser. No. 19/402,931. Stated differently, the carbonaceous material described in copending U.S. patent application Ser. No. 18/977,529 and in copending U.S. patent application Ser. No. 19/402,931 can be used as a shaped base sorbent or as a binder for other shaped carbonaceous materials, such as activated carbon provided by a different process and having a different composition.

The raw materials are typically homogenized and then assembled, shaped and densified into granules, more desirably into substantially spherical granules, such as 12×40, 8×30, or 4×10 mesh. Typically at least most (i.e., at least about 50%), more typically at least about 60%, more typically at least about 70%, at least about 75%, more typically at least about 80%, more typically at least about 85%, more typically at least about 90%, and more typically at least about 95% of the spheronized granulized material typically have a size ranging from about 0.2 to about 7.5 mm, more typically from about 0.25 to about 6 mm, and more typically from about 0.4 to about 5 mm.

The spheronized granulized material can be formed from a carbonaceous feedstock including purified coal product through homogenizing and reassembling with a green strength binder and optionally an activation binder in a spheronizer such as a pin mixer, disc/pan pelletizer or other spheronizing equipment to generate the shaped granules. In embodiments, there can be at least one green strength binder and/or sacrificial additive. The spheronized granulized material can be made from different carbonaceous materials. Purified coal products can be produced from grinding, washing and drying cycles depending on the applications (as further described in U.S. patent application Ser. No. 18/977,529 and U.S. patent application Ser. No. 19/402,931, which are herein incorporated by reference in their entirety).

The homogenized size of the carbonaceous material, along with pre-mixed binders (green strength, sacrificial additives, and/or activation binders), are fed into pin mixer or other spheronizer with water added to assemble and densify the carbonaceous feed into pre-determined sized granules that can be activated. The shaping/densifying conditions can be tuned to get the optimized screening yield for the targeted large granules. The carbonaceous granules can be screened as needed.

The GAC is typically produced through charring (to dehydrate, devolatilize, coke, heat-set, and carbonize) in a kiln and thermally activating (with steam to create surface area and porosity) in a high temperature furnace, such as a rotary kiln or a multi-hearth furnace. Charring of the densified spheronized granulized material is typically performed in a highly controlled process discussed below to control the thermosetting/coking properties of the raw material and thermally activated under unique, highly tuned conditions to yield a product with high sphericity and aspect ratio typically in the range of about 0.75 to about 1.0 and more typically about 1.0, and enhanced hardness and contaminant adsorption activity. Typically, at least most (i.e., at least about 50% by number), more typically at least about 60%, more typically at least about 70%, more typically at least about 75%, more typically at least about 80%, more typically at least about 85%, more typically at least about 90%, and more typically at least about 95% of the sorbent particles have a high sphericity as defined above.

Charring and thermally activating the densified spheronized granulized material is typically performed under unique, highly tuned conditions to yield a product with high sphericity and aspect ratio close to 1, and enhanced hardness and adsorption activity. The set of activation conditions typically uses an activation temperature of at least about 1500° F., more typically at least about 1600° F., and more typically at least about 1700° F. but typically no more than about 2000° F., more typically no more than about 1900° F., and more typically no more than about 1800° F.

While not wishing to be bound by any theory, it is believed that process increases the microporosity volume of the activated carbon due to increased gas penetration into the surfaces pores. Typically, the activated carbon has a micropore volume of at least about 0.3 cc/g and more typically of at least about 0.35 cc/g and more typically of at least 0.4 cc/g; A BET surface area of at least about 900 m²/g, and more typically of at least about 1000 m²/g, and more typically of at least 1100 m²/g, and even more typically of about 1200 m²/g. The carbon tetrachloride capacity of the activated carbon is typically at least about 50 wt %, more typically at least about 65 wt %, more typically at least about 70 wt %, more typically at least about 75 wt %, and more typically at least about 80 wt %.

The activated carbon sorbent can provide enhanced contaminant removal from the soil, liquid and gas streams as well as enhanced operational performance in a treatment vessel, such as for PFAS and other organics removal.

The substantially uniform spherically shaped large granules can have high hardness, close to 1 aspect ratio (width/length, or stated another way, length to diameter), improved physical integrity, and enhanced adsorption capability and/or enhanced field removal performance. By tuning the raw material, feed preparation, formulation additives, binders, and charring/coking/thermal activation profile when producing granular activated carbon, the final GAC product has preferable porosity, surface functionalities, structural and adsorptive properties for target contaminants, such as Taste and Odor in drinking water, PFAS removal, VOCs, hydrogen sulfide and siloxane in the biogas stream, etc. Optionally, additives may be incorporated into the carbonaceous feedstock and the activated carbon product for improved adsorption selectivity, capacity, catalytic effects, the removal of multiple contaminants at the same time, and/or reduced leaching of impurities. The spherical shape and size of the GAC can provide high hardness, low pressure drop with improved operational efficiencies, such as higher flowrates, reduced energy consumption, low dustiness, improved adsorption capacity for contaminants including PFAS and other organic contaminants in water treatment and remediation applications. The composition of matter in the present disclosure can contain elevated levels/volume of transport small mesopore volume (20-150 Å.

The spherically shaped activated carbon sorbent can be made from different carbonaceous materials. The raw material can be any carbonaceous material, such as anthracite coal, bituminous coal, subbituminous coal, lignite coal, remediated coal waste and other non-coking coals, coconut, pecan husks, olive pit, peat, wood, other hard or soft raw materials, or a blend of the foregoing. These raw materials can be used as a starting raw feed material for the process either as is or after further treatment to remove impurities, such as ash. The treated or purified carbonaceous material can be produced from grinding, washing and drying cycles depending on the applications. In either case, the raw feed material is typically a free-flowing particulate material having a relatively small primary particle size.

The raw carbonaceous material, whether purified in whole or part, can be homogenized and then assembled, shaped and densified into agglomerates or granules, more desirably into substantially spherical granules, such as by a spheronizer. The homogenized carbonaceous material, optionally pre-mixed with green strength and/or activation binders are typically fed along with water into a spheronizer, such as a pin mixer, disc/pan pelletizer or other spheronizing equipment, to (re) assemble and densify the carbonaceous materials into pre-determined sized shaped granules. The carbonaceous granules can be screened as needed. The process can be controlled to produce a high shaping yield. Using the purified carbonaceous product described above can provide the advantage of much smaller grain sizes and pre-conditioning, such as pre-oxidation and trace metal removal during washing and drying steps. Additives can be added during feed preparation steps, during activation, and/or post-activation.

The agglomerated shaped, densified carbonaceous material can be converted into GAC through charring (to dehydrate, devolatilize, and carbonize) in a highly controlled process to control the thermosetting/coking properties of the densified carbonaceous material followed by thermally activating (typically with steam to create surface area and porosity) under highly tuned conditions in a high temperature furnace, such as a rotary kiln or a multi-hearth furnace to yield an agglomerated activated carbon or densified spheronized granulized material having a substantially spherical shape.

The densified spheronized granulized material can be charred and thermally activated to yield a spherically shaped activated carbon sorbent with high sphericity typically in the range of about 0.75 to about 1.0, more typically in the range of about 0.85 to about 1.0, more typically in the range of about 0.9 to about 1.0, more typically in the range of about 0.95 to about 1.0, and more typically about 1.0, and aspect ratio typically in the range of at least about 0.7, more typically of more than about 0.75, and more typically of more than about 0.8 and enhanced hardness and contaminant adsorption activity. Typically, at least most (i.e., more than about 50%), more typically at least about 60%, more typically at least about 70%, more typically at least about 75%, more typically at least about 80%, more typically at least about 85%, more typically at least about 90%, and more typically at least about 95% of the sorbent particles have a high sphericity and aspect ratio as defined above.

The spherically shaped activated carbon sorbent can be used to remove contaminants in air, soil, and surface, ground, and wastewater. The spherically shaped activated carbon sorbent can realize enhanced contaminant removal not only from the soil, liquid and gas streams but also through enhanced operational performance in a treatment vessel.

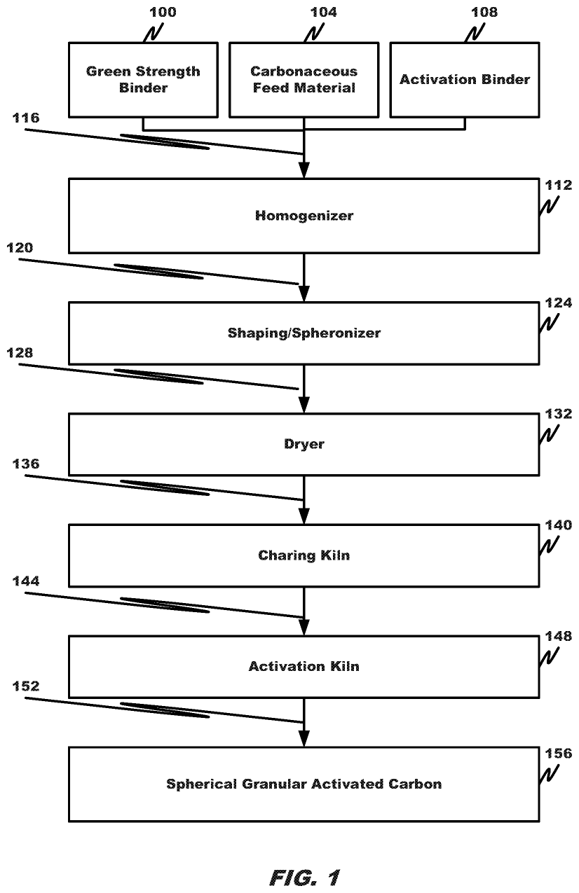

A process to manufacture the spherically shaped activated carbon sorbent will be discussed in connection with FIG. 1.

In a first step, a green strength binding agent or binder 100, carbonaceous feed material 104, and activation binding agent or binder 108 are blended and homogenized in a homogenizer 112 to form a homogenized feed mixture 120. Depending on the application, the green strength binding agent or activation binding agent may or may not be used.

The green strength binding agent 100 can be any suitable green strength binder that increases the green strength of agglomerates formed from the homogenized carbonaceous feed material. Examples of green strength binding agents include without limitation carboxymethyl cellulose, carboxymethylhydrocellulose (CMHC), hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethyl-methyl cellulose, enriched methyl-hydroxypropyl cellulose MHPC, and other cellulose derivatives, xanthan gum and derivatives thereof, guar gum and derivatives thereof (such as hydroxypropyl guar gum), tragacanth gum and derivatives thereof, polyacrylates and derivatives thereof (e.g., acrylates/C10-C30 alkyl acrylate cross-polymer, carbomer, and polyacrylate-1 cross-polymer), agarose, casein, starch, poly(vinylidene difluoride) (PVDF), poly[1-(2-oxo-1-pyrrolidinyl)ethylene] (POPE), polytetrafluoroethylene (PTFE), n-methyl-2-pyrrolidone (NMP), polyvinylidene fluoride (PVDF), and other natural polymers, gelatin, chitosan, alginate, other organic and inorganic binders, and mixtures thereof. In embodiments, the amount of binder used can commonly be about 0.10 wt % to about 10 wt %, more commonly about 0.25 wt % to about 5 wt %, and even more commonly from about 0.5 wt % to about 2 wt %.

In embodiments, the green strength binder can be separate from the sacrificial additive. The sacrificial additive may be any organic constituent that can be incorporated into the shaped particle and will decompose or volatilize at charring or activation temperatures described in the present disclosure. In a typical application, typically at least most, more typically at least about 75%, more typically at least about 80%, more typically at least about 85%, more typically at least about 90%, more typically at least about 95%, more typically at least about 97%, more typically at least about 99%, or more typically substantially all, of the sacrificial additive decomposes or volatilizes and leaves at least pores and optionally also intragranular channels and intergranular channels. In embodiments, typically at least about 50% to not more than about 100% of the sacrificial additive can be volatilized or decomposed, or more typically from about 55% to about 99%, more typically from about 60% to about 98%, or even more typically about 70% to about 95% of the sacrificial additive can be volatilized or decomposed. Additionally or alternatively, typically at least about 50%, more typically at least about 60%, more typically at least about 70%, more typically at least about 80%, more typically at least about 90%, more typically at least about 95%, more typically at least about 97%, or even more typically at least about 99% of the sacrificial additive can volatilize or decompose. Additionally or alternatively, typically no more than about 100%, more typically no more than about 99%, more typically no more than about 98%, more typically no more than about 97%, more typically no more than about 95%, more typically no more than about 90%, more typically no more than about 80%, or more typically no more than about 75% of the sacrificial additive can volatilize or decompose. In embodiments, at least most of the sacrificial additive is absent from the sorbent composition. Sacrificial additive may include, but are not limited to, hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethyl-methyl cellulose, starches & other carbohydrates, xanthan gum derivatives, guar gum derivatives, hydroxypropyl guar gum, Polyacrylates derivatives, Acrylates/C10-C30 Alkyl Acrylate cross-polymer, Carbomer, Polyacrylate-1 cross-polymer, sugar, sugar alcohols, fatty acids, long-chain alkanes (like paraffin wax), lignosulfonates and nanofibers.

The carbonaceous feed material 104 can be any hard or soft carbon-rich raw material, such as anthracite coal, bituminous coal, subbituminous coal, lignite coal, and other non-coking coals, cellulosic, coconut, pecan husks, olive pit, peat, wood, other hard or soft raw materials, or a blend of the foregoing. The carbonaceous feed material can be reclaimed from waste reserves, naturally occurring materials such as coal, and have a low carbon dioxide footprint. The carbonaceous feed material 104 typically has an ash content of no more than about 10 wt %, more typically no more than about 9 wt %, more typically no more than about 8 wt %, more typically no more than about 7 wt %, more typically no more than about 6 wt %, and more typically no more than about 5 wt %, a free swelling index of typically more than about 1 and more typically more than about 2 but typically no more than about 5. The carbonaceous feed material 104 typically has a D50 size distribution of no more than about 100 microns, more typically no more than about 80 microns, more typically no more than about 70 microns, more typically no more than about 60 microns, more typically no more than about 50 microns, more typically no more than about 40 microns, more typically no more than about 30 microns, more typically no more than about 20 microns, and more typically no more than about 10 microns.

In some applications, the carbonaceous feed material 104 is a purified, typically small, particle-sized coal product or similar carbon-rich feed material. The purified carbonaceous feed material typically has an ash content of less than about 5 wt %, more typically less than about 4 wt %, more typically less than about 3 wt %, more typically less than about 2 wt %, and more typically less than about 1 wt %. The purified carbonaceous feed material 104 in such applications can be a carbonaceous feed material optionally subjected to water washing or froth flotation to separate hydrophobic materials in an overflow from hydrophilic materials in an underflow. Most of the ash is removed in the underflow while the carbonaceous feed material is removed in the overflow. The ash removal process and resulting purified carbonaceous feed material is further discussed in copending U.S. Pat. No. 18,574,432, filed Jun. 29, 2022 (now published as US20240317589), which is incorporated fully herein by this reference. In the process, the raw carbonaceous material is milled to a particle size of D50 size typically ranging from about 1-20 microns; the milled material formed into a slurry having a typical solids content in the range of about 5-40 wt % solids; the ash and other mineralized hydrophobic materials separated from the hydrophilic coal by floating the slurry in one or more stages of froth flotation in the presence of a suitable frother (e.g., methyl iso-butyl carbinol and pine oil) and collector (e.g., diesel fuel or other hydrocarbon oil, and Nasmin AP7™ from Nasaco International Company; the hydrophilic materials containing coal particles is dewatered, such as by a filter press or tube press to a target range of typically about 20-50 wt % solids and typically about 50-80 wt % water under pressure or vacuum to form a dewatered coal-containing product; and the dewatered coal-containing product dried thermally to form the purified carbonaceous material having a reduced water content of typically no more than about 10 wt % water. In other applications, most of the ash and other mineralized content is removed from the carbonaceous feed material through milling, washing and drying cycles The dried purified carbonaceous material has thermoplastic/free swelling/coking properties that can be carefully controlled in the charring step to reduce inter-primary particle void space within the shaped granules and realize an enhanced intra-granule pore characteristic for enhanced contaminant adsorption selectivity, capacity and kinetics.

In embodiments, the carbonaceous feed material 104 can be comprised of typically about 50 wt % to about 90 wt % bituminous coal on a dry weight basis. Additionally or alternatively, the carbonaceous feed material 104 can be comprised of, on a dry weight basis, typically at least about 50 wt %, more typically at least about 55 wt %, more typically at least about 60 wt %, more typically at least about 65 wt %, or more typically at least about 70 wt % bituminous coal. Additionally or alternatively, the carbonaceous feed material 104 can be comprised of, on a dry weight basis, typically no more than about 99 wt %, more typically no more than about 95 wt %, more typically no more than about 90 wt %, more typically no more than about 85 wt %, or more typically no more than about 80 wt % bituminous coal.

The purified carbonaceous feed material can be used as a green strength binder for agglomerates formed from the carbonaceous feed material 104. Stated differently, the purified carbonaceous material described in the above-referenced application can be used as a green strength binder for the higher ash carbonaceous feed material.

The activation binding agent 108 can be any suitable activation binder that enhances the integrity and shaping of the carbonaceous material at the activation temperature. Exemplary activation binding agents include without limitation phenol-formaldehyde resin, polyvinyl acetate, gilsonite, resinous rock, asphalt, uintahite, coal tar pitch, petroleum pitch, oil sands, bitumen, resinous hydrocarbon, heavy oil, carbon pitch, coal tar distillates, clays such as bentonite, gas generator tar, and mixtures thereof. In embodiments, the activation binder can be used in amounts commonly less than about 10 wt %, more commonly between about 1 wt % to about 5 wt %, or even more commonly between about 2 wt % to about 4 wt %. In embodiments, the activation binder is optional and may not be required where the carbonaceous feed 104 inherently contains sufficient coking properties.

The feed mixture 116 typically comprises from about 0.1 to about 15 wt %, more typically from about 0.1 to about 10 wt %, more typically from about 0.15 to about 7.5 wt %, more typically from about 0.25 to about 5 wt %, and more typically from about 0.5 to about 2 wt % of the green strength binder 100, from about 0 to about 10 wt %, more typically from about 0.1 to about 10 wt %, more typically from about 0.1 to about 7.5 wt %, more typically from about 1 to about 5 wt %, and more typically from about 2 to about 4 wt % of the activation binder 100, and typically from about 5 to about 30 wt % and even more typically from about 10 to about 25 wt % water, with the balance being the carbonaceous feed material 104. The activation binder can be omitted when the carbonaceous feed material inherently has sufficient coking properties. Coking coals are typically coals that soften, swell, liquify and then solidify as they are heated through the temperature range 350-550° C. Such coals commonly have a low ash content (e.g., from about 1-10 wt %), a low permeability as determined by inherent moisture, a moderate vitrinite content (to provide volatile matter) and volatile matter typically in the range 18-45 wt %.

The feed mixture 116 is next subjected to homogenization in the homogenizer 112 to form the homogenized feed mixture 120. Homogenization typically synergistically mixes the various components to form a substantially homogenous mixture. The homogenizer 112 can be any mechanical mixing device, such as a paddle mixer, pug mill, and the like. Mixing is performed for a sufficient time to provide a homogenized feed material 120 that has a delumped or aggregated coal reduced D₅₀ particle size to typically no more than about 100 μm, more typically no more than about 50 μm, and more typically less than about 20 μm and/or typically has a delumped or aggregated coal reduced D₉₀ particle size to typically no more than about 90 μm. The homogenized feed mixture 120 optionally has a moisture content of typically at least about 5 wt % and more typically at least about 10 wt % but typically no more than about 40 wt %, more typically no more than about 30 wt %, and more typically no more than about 25 wt %.

The homogenized feed mixture 120 is shaped and spheronized in step 124 to form spheronized agglomerates 128. The spheronized agglomerates 128 have a high sphericity and aspect ratio typically in the range of about 0.75 to about 1.0 and more typically about 0.9. Typically, at least most (i.e., more than about 50%), more typically at least about 60%, more typically at least about 70%, more typically at least about 75%, more typically at least about 80%, more typically at least about 85%, more typically at least about 90%, and more typically at least about 95% of the spheronized agglomerates 128 have a high sphericity as defined above. The shaping and spheronization can be performed using any suitable device, such as an extruder, tablet press, pin mixer, marumerizer, pan pelletizer, or other spheronization equipment. As will be appreciated, extrusion is generally performed prior to spheronization. The size of the spheres is determined by the diameter of the homogenized feed mixture used for the spheronization process. For example, to obtain spheres with a diameter of 1 mm, a 1 mm screen can be used on an extruder, although spheres with a slightly bigger diameter can sometimes be obtained. In the spheronizer, the diameter of the spherical agglomerates typically ranges from about 0.2 mm to about 10 mm.

In a typical spheronizer, a rotating friction disk increases friction with the product, which spins at a high speed at the bottom of a cylindrical bowl. The spinning friction disc has a carefully designed groove pattern on the processing surface. This pattern is most often crosshatched, but several sizes and other types are available. The homogenized feed mixture 120 is charged to the spheronizer and fall on the spinning disc. At first, the cylindrical homogenized feed mixture segments are cut into segments with a length ranging from 1 to 1.2 times the diameter. These segments then collide with the bowl wall and are thrown back to the inside of the friction plate. Centrifugal force sends the material to the outside of the disc. The action of the material being moved causes the homogenized feed mixture to be broken down into pieces of approximately equal length relative to the diameter of the homogenized feed mixture. These cylindrical segments are gradually rounded by the collisions with the bowl wall, the plate and each other. The ongoing action of particles colliding with the wall and being thrown back to the inside of the plate creates a “rope-like” movement of product along the bowl wall. The continuous collision of the particles with the wall and friction plate gradually turn the cylindrical segments into spheres, provided that the granules are plastic enough to allow the deformation without being destroyed. When the particles have obtained the desired spherical shape, the discharge valve of the chamber is opened and the granules are discharged by the centrifugal force. The shaping yield is typically at least about 85%, more typically at least about 90%, and more typically at least about 95%.

The spheronized agglomerates are dried in drying step 132 to create a green strength typically of more than about 45% Ball Pan Hardness (BPH), more typically of more than about 60% BPH, and more typically of more than about 80% BPH. The drying temperature is typically less than about 400° F., more typically less than about 300° F., and more typically less than about 200° F. After drying, the water content of the dried spheronized agglomerates 136 is typically no more than about 40 wt % and more typically no more than about 30 wt %. In embodiments, the water content can be typically no more than about 25 wt %. The spheronized agglomerates typically have an ash content of no more than about 15 wt % and even more typically no more than about 10 wt % (dry basis) for municipal water purifications and ash content of no more than 30 wt %, even more typically no more than about 25 wt %, and even more typically no more than about 20 wt % for non-municipal applications.

The dried spheronized agglomerates 136 are charred in a charring kiln 140 to form charred agglomerates 144. The charring kiln 140 can be any suitable type of kiln, such as a direct or indirect fired counter-current or co-current rotary kiln. The dried spheronized agglomerates 136 are thermally dehydrated, devolatilized and carbonized in the charring kiln at temperature typically no higher than about 1200° F., more typically no more than about 1100° F., more typically no higher than about 1000° F., and more typically no higher than about 800° F. . . . The purge gas during charring typically has a molecular oxygen level of no more than about 10 vol %, more typically no more than about 5 vol %, and more typically no higher than about 2 vol %. The charred agglomerates 144 have a moisture content of typically no more than about 15 wt %, more typically no more than about 10 wt %, and more typically no more than about 5 wt % moisture, and a volatile matter content of less than about 20 wt %. While not wishing to be bound by any particular theory, it is believed that the heating of the coal feed through the multistage dryer drives the moisture off the surface of the dried spheronized agglomerates 136 and by diffusion the moisture in the center of the dried spheronized agglomerates 136 is drawn to the surface of the coal feed particle. The heating is such that the center of the dried spheronized agglomerates 136 is not heated sufficiently to cause the moisture or volatile matter to crack off, thus limiting the fracturing of the dried spheronized agglomerates 136 by evolution of moisture or volatile matter in a gas form from the center of the dried spheronized agglomerates 136. In some applications using a rotary kiln, the rotary kiln will typically have a rotation speed of about 0.5-4 rpm depending on the size of the dried spheronized agglomerates and the size of the rotary kiln heat tube.

The charred agglomerates 144 are thermally activated 148 in an activation kiln or high temperature furnace, such as a rotary kiln or a multi-hearth furnace, to produce spherical granular activated carbon particulates 156. Activation is typically thermally activated at temperatures range from about 1400° F. to about 2000° F., more typically from about 1500° F. to about 1900° F., and more typically from about 1600° F. to about 1800° F. The steam-to-fixed carbon ratio typically ranges from about 5:1 to about 0.5:1, more typically from about 4:1 to about 0.8:1, and more typically from about 3.5:1 to about 1:1.

In embodiments, pre-shaping and post-activation additives can be used to tune the properties of the spherical granular activated carbon sorbent particulates for the desired application.

In embodiments, the steps in the process disclosed can occur in combination or as individual steps in the production process.

The spherical granular activated carbon sorbent particulates 156 or activated carbon sorbent typically include a carbon content of at least about 75 wt %, more typically at least about 80 wt./%, more typically at least about 85 wt %, and more typically at least about 90 wt % and can have a high activity, a high hardness (e.g., be a hard sorbent composition), a high aspect ratio (e.g., width/length ratio), an improved physical integrity, and/or an enhanced adsorption capability. The spherical granular activated carbon sorbent particulates 156 typically have one or more of: a sphericity ranging from about 0.86 and about 1.0, more typically between about 0.90 and about 1.0, and more typically between about 0.95 and about 1.0; an aspect ratio typically greater than about 0.71, more typically greater than about 0.75, and more typically greater than about 0.80; a dustiness typically less than about 0.2 wt % and more typically less than about 0.1 wt %; a ball pan hardness typically greater than about 60%, more typically greater than about 75%, more typically greater than about 80%, more typically greater than about 90%, and more typically greater than about 95%; an abrasion number typically greater than about 60%, more typically greater than about 75%, and even more typically greater than about 80%; an apparent density of 8×30 size typically ranging from about 0.3 to 0.7 g/cc, more typically ranging from about 0.35 to 0.65 g/cc, and more typically ranging from about 0.45 to 0.55 g/cc; an apparent density of 12×40 size typically ranging from about 0.3 to 0.7 g/cc, more typically ranging from about 0.4 to 0.65 g/cc, and more typically ranging from about 0.45 to 0.55 g/cc; a mercury intrusion particle density typically below about 0.95 g/cc, and more typically below about 0.9 g/cc; a pH range for particulates typically above about 7.5 and more typically above about 8.5; a micropore volume typically of at least about 0.35 cc/g, more typically at least about 0.36 cc/g, more typically at least about 0.37 cc/g, and more typically at least about 0.38 cc/g; a mesopore volume typically of more than about 0.25 cc/g, more typically at least about 0.26 cc/g, more typically at least about 0.27 cc/g, and more typically at least about 0.28 cc/g; a small mesopore volume typically of more than about 0.17 cc/g, more typically at least about 0.18 cc/g, more typically at least about 0.19 cc/g, more typically at least about 0.20 cc/g, more typically at least about 0.21 cc/g, and more typically at least about 0.22 cc/g; a DFT micro+mesopore volume typically of more than about 0.57 cc/g, more typically at least about 0.58 cc/g, more typically at least about 0.59 cc/g, more typically at least about 0.60 cc/g, more typically at least about 0.61 cc/g, more typically at least about 0.62 cc/g, more typically at least about 0.63 cc/g, more typically at least about 0.64 cc/g, and more typically at least about 0.65 cc/g; and a TGA wt. loss % (400 to 750° C.) typically of no more than about 0.35%, more typically no more than about 0.30%, and more typically no more than about 0.25%.

The spherical granular activated carbon particulates 156 can be comprised of typically at least about 90 wt % bituminous coal, typically no more than about 0.5 wt % green strength binder, and typically no more than about 2 wt % moisture. In embodiments, the spherical granular activated carbon particulates 156 on a dry basis can be comprised of typically at least about 90 wt % bituminous coal, more typically at least about 92 wt %, more typically at least about 94 wt %, more typically at least about 96 wt %, or even more typically at least about 98 wt % bituminous coal. In embodiments, the spherical granular activated carbon particulates 156 on a dry basis can be comprised of bituminous coal ranging typically from about 75 wt % to about 95 wt %, more typically from about 80 wt % to about 95 wt %, or more typically from about 85 wt % to about 90 wt %. Additionally or alternatively, the spherical granular activated carbon particulates 156 on a dry basis can be comprised of typically no more than about 99 wt %, more typically no more than about 98 wt %, more typically no more than about 97 wt %, more typically no more than about 96 wt %, or more typically no more than about 95 wt % bituminous coal. In embodiments, the bituminous coal component can be comprised of ash and volatile compounds from the carbonaceous feed material. In embodiments, the green strength binder in the spherical granular activated carbon particulates 156 can be typically no more than about 0.5 wt %, more typically no more than about 0.4 wt %, more typically no more than about 0.3 wt %, more typically no more than about 0.2 wt %, more typically no more than about 0.1 wt %, or even more typically 0.0 wt % of green strength binder. In embodiments, the green strength binder in the spherical granular activated carbon particulates 156 can be from typically about 0 wt % to no more than about 0.1 wt %, more typically from about 0.01 wt % to about 0.09 wt %, or more typically from about 0.02 wt % to about 0.05 wt %.

Compared to conventional activated carbon particulates, the spherical granular activated carbon particulates 156 can have a BET (Brunauer-Emmett-Teller) surface area (e.g., measured by Nitrogen Porosimetry) of at least double, optionally more than double, even up to a three-fold increase and more favorable average pore diameter and pore volume (e.g., as modeled by DFT) for contaminant removal. The BET surface area can typically be at least about 500 m²/g and more typically at least about 1000 m²/g; the DFT micro+mesopore volume ranges from about 0.3 to about 0.9 cc/g and more typically from about 0.5 to about 0.7 cc/g.

The BET surface area of the spherical granular activated carbon particulates 156 can commonly be at least about 900 m²/g, more commonly at least about 920 m²/g, more commonly at least about 940 m²/g, more commonly at least about 960 m²/g, more commonly at least about 980 m²/g, more commonly at least about 1000 m²/g, more commonly at least about 1020 m²/g, more commonly at least about 1040 m²/g, more commonly at least about 1060 m²/g, more commonly at least about 1080 m²/g, more commonly at least about 1100 m2/g, more commonly at least about 1120 m²/g, more commonly at least about 1140 m²/g, more commonly at least about 1140 m²/g, or even more commonly at least about 1150 m²/g.

The pore volume of the activated carbon sorbent 156 for pores less than 1,000 Å, as measured by N₂ porosimetry, can be between about 0.50 cc/g to about 0.90 cc/g. More commonly, the pore volume for pores less than 1,000 Å can be between about 0.55 cc/g to about 0.85 cc/g, or more commonly between about 0.60 cc/g to about 0.80 cc/g. In embodiments, the total pore volume for pores less than 1,000 Å can be typically at least about 0.60 cc/g, more typically at least about 0.61 cc/g, more typically at least about 0.62 cc/g, more typically at least about 0.63 cc/g, more typically at least about 0.64 cc/g, more typically at least about 0.65 cc/g, more typically at least about 0.66 cc/g, more typically at least about 0.67 cc/g, more typically at least about 0.68 cc/g, more typically at least about 0.69 cc/g, more typically at least about 0.70 cc/g, more typically at least about 0.71 cc/g, more typically at least about 0.72 cc/g, more typically at least about 0.73 cc/g, more typically at least about 0.74 cc/g, or more typically at least about 0.75 cc/g. In embodiments, additionally or alternatively, the total pore volume for pores less than 1,000 Å can be commonly no more than about 0.90 cc/g, more commonly no more than about 0.88 cc/g, more commonly no more than about 0.86 cc/g, more commonly no more than about 0.84 cc/g, more commonly no more than about 0.82 cc/g, or more commonly no more than about 0.80 cc/g.

In embodiments, the activated carbon sorbent 156 can have a large meso- and macropore volume, with pores inclusively between about 150 Å to about 1,000 Å, measured by N₂ porosimetry, can be in the range of typically about 0.04 cc/g to about 0.12 cc/g, more typically about 0.06 cc/g to about 0.10 cc/g, or more typically about 0.07 cc/g to about 0.09 cc/g. Additionally or alternatively, the large meso- and macropore volume can be typically greater than about 0.05 cc/g, more typically greater than about 0.06 cc/g, or even more typically greater than about 0.07 cc/g. Additionally or alternatively, the large meso- and macropore volume can be typically not greater than about 0.15 cc/g, more typically not greater than about 0.14 cc/g, more typically not greater than about 0.13 cc/g, more typically not greater than about 0.12 cc/g, more typically not greater than about 0.12 cc/g, more typically not greater than about 0.11 cc/g, more typically not greater than about 0.10 cc/g, or even more typically not greater than about 0.09 cc/g.

The mesopore volume of the activated carbon sorbent 156, where the pores are inclusively between 20 Å through 500 Å, can be commonly between about 0.20 cc/g to about 0.40 cc/g. In embodiments, the mesopore volume can be typically at least about 0.20 cc/g, more typically at least about 0.21 cc/g, more typically at least about 0.22 cc/g, more typically at least about 0.23 cc/g, more typically at least about 0.24 cc/g, more typically at least about 0.25 cc/g, more typically at least about 0.26 cc/g, more typically at least about 0.27 cc/g, more typically at least about 0.28 cc/g, more typically at least about 0.29 cc/g, more typically at least about 0.30 cc/g, more typically at least about 0.31 cc/g, more typically at least about 0.32 cc/g, more typically at least about 0.33 cc/g, more typically at least about 0.34 cc/g, or more typically at least about 0.35 cc/g. Additionally or alternatively, in embodiments, the mesopore volume can be commonly no more than about 0.40 cc/g, commonly no more than about 0.39 cc/g, commonly no more than about 0.38 cc/g, commonly no more than about 0.37 cc/g, commonly no more than about 0.36 cc/g, or commonly no more than about 0.35 cc/g.

In embodiments, the small mesopore volume of the activated carbon sorbent 156, with a pore size range inclusively of about 20 Å to about 150 Å and measured by N₂ porosimetry can be commonly about 0.10 cc/g to about 0.35 cc/g, more commonly about 0.12 cc/g to about 0.30 cc/g, or even more commonly about 0.15 cc/g to about 0.25 cc/g. Additionally or alternatively, the small mesopore volume can be typically greater than about 0.08 cc/g, more typically greater than about 0.10 cc/g, more typically greater than about 0.12 cc/g, more typically greater than about 0.14 cc/g, more typically greater than about 0.16 cc/g, more typically greater than about 0.18 cc/g, or more typically greater than about 0.20 cc/g. Additionally or alternatively, the small mesopore volume can be typically no greater than about 0.26 cc/g, more typically no greater than about 0.24 cc/g, more typically no greater than about 0.22 cc/g, more typically no greater than about 0.20 cc/g, more typically no greater than about 0.18 cc/g, or even more typically no greater than about 0.16 cc/g. In embodiments, the small mesopores can be used for transport for at least one contaminant during sorbent treatment.

In embodiments, the transport pore volume of the activated carbon sorbent 156, with a pore size range inclusively of about 2 to about 10 times the molecular diameter of the target contaminant and measured by N₂ porosimetry can be typically about 0.10 cc/g to about 0.35 cc/g, more typically about 0.12 cc/g to about 0.30 cc/g, or even more typically about 0.15 cc/g to about 0.25 cc/g. Additionally or alternatively, the transport pore volume can be typically greater than about 0.08 cc/g, more typically greater than about 0.10 cc/g, more typically greater than about 0.12 cc/g, more typically greater than about 0.14 cc/g, more typically greater than about 0.16 cc/g, more typically greater than about 0.18 cc/g, or more typically greater than about 0.20 cc/g. Additionally or alternatively, the transport pore volume can be typically no greater than about 0.26 cc/g, more typically no greater than about 0.24 cc/g, more typically no greater than about 0.22 cc/g, more typically no greater than about 0.20 cc/g, more typically no greater than about 0.18 cc/g, or even more typically no greater than about 0.16 cc/g. In embodiments, the transport pores can have the same size range as small mesopores, which have a pore size from about 20 Å to about 150 Å. In embodiments, the transport pores can be from about 2 to about 10 times the molecular diameter of the target contaminant. In embodiments, the transport pores can be from about 2 to about 10 times the molecular diameter of per- and poly-fluoroalkyl substances.

The micropore volume of the activated carbon sorbent 156, where the pores are equal to or less than 20 Å, can be typically between about 0.30 cc/g to about 0.50 cc/g. In embodiments, the micropore volume can be typically at least about 0.30 cc/g, more typically at least about 0.31 cc/g, more typically at least about 0.32 cc/g, more typically at least about 0.33 cc/g, more typically at least about 0.34 cc/g, more typically at least about 0.35 cc/g, more typically at least about 0.36 cc/g, more typically at least about 0.37 cc/g, more typically at least about 0.38 cc/g, more typically at least about 0.39 cc/g, more typically at least about 0.40 cc/g, more typically at least about 0.41 cc/g, more typically at least about 0.42 cc/g, more typically at least about 0.42 cc/g, more typically at least about 0.43 cc/g, more typically at least about 0.44 cc/g, or more typically at least about 0.45 cc/g. In embodiments, additionally or alternatively, the micropore volume can be commonly no more than about 0.50 cc/g, commonly no more than about 0.49 cc/g, commonly no more than about 0.48 cc/g, commonly no more than about 0.47 cc/g, commonly no more than about 0.46 cc/g, or commonly no more than about 0.45 cc/g. In embodiments, the micropores can be used to sequester the at least one target contaminant.

In embodiments, sequestration pores are about 1 to about 2 times the molecular diameter of the target contaminant. In embodiments, the sequestration pore volume in the activated carbon sorbent 156, as measured by N₂ porosimetry is commonly about 0.30 cc/g to about 0.60 cc/g. More commonly, the sequestration pore volume in the activated carbon sorbent 156 is typically about 0.35 cc/g to about 0.55 cc/g, more typically about 0.38 cc/g to about 0.50 cc/g, or even more typically about 0.40 cc/g to about 0.45 cc/g. Additionally or alternatively, the sequestration pore volume is typically at least about 0.34 cc/g, more typically at least about 0.36 cc/g, more typically at least about 0.38 cc/g, more typically at least about 0.40 cc/g, or even more typically at least about 0.42 cc/g. Additionally or alternatively, the sequestration pore volume can be typically less than about 0.50 cc/g, more typically less than about 0.48 cc/g, more typically less than about 0.46 cc/g, more typically less than about 0.44 cc/g, more typically less than about 0.42 cc/g, or more typically less than about 0.40 cc/g. In embodiments, the sequestration pores can have the same size range as micropores, which have a pore size of no more than about 20 Å. In embodiments, the sequestration pores can be from about 1 to about 2 times the molecular diameter of the target contaminant. In embodiments, the sequestration pores can be from about 1 to about 2 times the molecular diameter of per- and poly-fluoroalkyl substances.

In embodiments, the activated carbon sorbent 156 can comprise intragranular channels—at least about 1,000 Å in width, as measured by Hg intrusion, where the activated carbon sorbent 156 can have a volume between typically about 0.14 cc/g to about 0.50 cc/g, more typically about 0.180 cc/g to about 0.45 cc/g, or even more typically between about 0.20 cc/g to about 0.40 cc/g of intragranular channels. Additionally or alternatively, the intragranular channel volume in the activated carbon sorbent 156 can be typically greater than about 0.10 cc/g, more typically greater than about 0.15 cc/g, more typically greater than about 0.20 cc/g, more typically greater than about 0.25 cc/g, more typically greater than about 0.30 cc/g, more typically greater than about 0.35 cc/g, or more typically greater than about 0.40 cc/g. Additionally or alternatively, the intragranular channel volume can be typically less than about 0.55 cc/g, more typically less than about 0.52 cc/g, more typically less than about 0.50 cc/g, more typically less than about 0.48 cc/g, more typically less than about 0.46 cc/g, or even more typically less than about 0.44 cc/g.

In embodiments, the ash content of the activated carbon sorbent 156 as measured by thermogravimetric analysis (TGA) can be about 12.5 wt. %. More commonly, the ash content can be between about 5 wt. % to about 20 wt. %, more commonly between about 8 wt. % to about 15 wt. %, more commonly between about 10 wt. % to about 14 wt. %, or even more commonly between about 12 wt. % to about 13 wt. %. Additionally or alternatively, the ash content as measured by TGA can be typically greater than about 6 wt %, more typically greater than about 7 wt %, more typically greater than about 8 wt %, more typically greater than about 9 wt %, or even more typically greater than about 10 wt %. Additionally or alternatively, the ash content can be typically not greater than about 20 wt %, more typically not greater than about 18 wt %, more typically not greater than about 16 wt %, more typically not greater than about 15 wt %, or more typically not greater than about 14 wt %.

As a non-limiting example, the volumes of apparent density, ash, micro- and meso-pore volume, sequestration micropores, transport small mesopores, and large meso- and macro-pores can be expressed as a volume precent in a vessel fill, which can be calculated using GAC apparent density, pore volumes from N₂ porosimetry and Hg intrusion, and assuming the activated carbon comprises ash that is at least mostly, if not nearly all, SiO₂ with a remainder being predominantly amorphous carbon. The ash can comprise typically at least about 50 wt % SiO₂, more typically at least about 60 wt %, more typically at least about 70 wt %, more typically at least about 80 wt %, more typically at least about 90 wt %, or more typically at least about 95 wt % SiO₂.

In embodiments, the total pore volume percent of pores having a pore size less than about 1,000 Å in a vessel fill can range from typically about 20 vol % to about 40 vol %, more typically from about 22 vol % to about 38 vol %, or more typically from about 25 vol % to about 35 vol %. Additionally or alternatively, the total pore volume percent can be typically greater than about 25 vol %, more typically greater than about 28 vol %, more typically greater than about 30 vol %, or more typically greater than about 32 vol %. Additionally or alternatively, the total pore volume percent can be typically no more than about 40 vol %, more typically no more than about 38 vol %, or more typically no more than about 36 vol %.

In embodiments, the micropore volume percent in the activated carbon sorbent 156 in a vessel fill, with pores less than or equal to about 20 Å, can be typically from about 10 vol % to about 35 vol %, more typically from about 12 vol % to about 30 vol %, or more typically from about 15 vol % to about 25 vol %. Additionally or alternatively, the micropore volume percent can be typically greater than about 12 vol %, more typically greater than about 14 vol %, more typically greater than about 16 vol %, or more typically greater than about 18 vol %. Additionally or alternatively, the micropore volume percent can be typically no more than about 30 vol %, more typically no more than about 28 vol %, more typically no more than about 26 vol %, more typically no more than about 24 vol %, more typically no more than about 22 vol %, or more typically no more than about 20 vol %.

In embodiments, the PFAS sequestration pore volume percent in the activated carbon sorbent 156 in a vessel fill, with pores having a pore size of about 7 Å to about 26 Å, can be typically from about 5 vol % to about 20 vol %, more typically from about 6 vol % to about 15 vol %, or more typically from about 8 vol % to about 12 vol %. Additionally or alternatively, the sequestration pore volume percent can be typically greater than about 5 vol %, more typically greater than about 6 vol %, more typically greater than about 7 vol %, more typically greater than about 8 vol %, or more typically greater than about 9 vol %. Additionally or alternatively, the sequestration pore volume percent can be typically no more than about 20 vol %, more typically no more than about 18 vol %, more typically no more than about 16 vol %, more typically no more than about 15 vol %, more typically no more than about 14 vol %, more typically no more than about 13 vol %, or more typically no more than about 12 vol %.

In embodiments, the volume percent of small meso or transport pores that can be used for transport in activated carbon sorbent 156, as calculated for a vessel fill, with a pore size from about 20 Å to about 150 Å, is typically between about 5.0 vol % to about 15.0 vol %, more typically between about 6.0 vol % to about 12.0 vol %, or even more typically between about 7.0 vol % to about 10.0 vol %. Additionally or alternatively, the small meso or transport pore volume can be typically at least about 5.0 vol %, more typically at least about 6.0 vol %, more typically at least about 7.0 vol %, more typically at least about 8.0 vol %, more typically at least about 9.0 vol %, or more typically at least about 10 vol %. Additionally or alternatively, the small meso or transport pore volume can be typically less than about 15.0 vol %, more typically less than about 14.0 vol %, more typically less than about 13.0 vol %, more typically less than about 12.0 vol %, or more typically less than about 10.0 vol %.

In embodiments, the volume percent of large mesopores and macropores, from about 150 Å to about 1,000 Å in size, can typically range from about 2 vol % to about 8 vol %. Additionally or alternatively, the volume percent of large mesopores and macropores can be typically greater than about 2 vol %, more typically greater than about 3 vol %, more typically greater than about 4 vol %, or more typically greater than about 5 vol %. Additionally or alternatively, the volume percent of large mesopores and macropores can be typically less than about 10 vol %, more typically less than about 9 vol %, more typically less than about 8 vol %, more typically less than about 7 vol %, or more typically less than about 6 vol %.

In embodiments, the volume percent of solid activated carbon can be typically from about 10 vol % to about 30 vol %, or more typically from about 15 vol % to about 25 vol %. Additionally or alternatively, the volume percent of solid activated carbon can be typically greater than about 10 vol %, more typically greater than about 12 vol %, more typically greater than about 14 vol %, more typically greater than about 16 vol %, or more typically greater than about 18 vol %. Additionally or alternatively, the volume percent of solid activated carbon can be typically less than about 30 vol %, more typically less than about 28 vol %, more typically less than about 26 vol %, more typically less than about 24 vol %, or more typically less than about 22 vol %.

In embodiments, the percent volume of void space can be typically from about 30 vol % to about 60 vol %, or more typically from about 33 vol % to about 55 vol %.

Additionally or alternatively, the percent volume of void space can be typically greater than about 30 vol %, more typically greater than about 35 vol %, or more typically greater than about 40 vol %. Additionally or alternatively, the percent volume of void space can be typically less than about 60 vol %, more typically less than about 55 vol %, more typically less than about 50 vol %, or more typically less than about 45 vol %.

In embodiments, the volume percent of micropores out of the total pore volume in the activated carbon sorbent 156, having a pore size of no more than about 20 Å, can range from typically about 45 vol % to about 70 vol %, more typically from about 48 vol % to about 68 vol %, or more typically from about 45 vol % to about 65 vol %. Additionally or alternatively, the micropore volume percent of total pore volume can be typically at least about 45 vol %, more typically at least about 50 vol %, more typically at least about 53 vol %, or even more typically at least about 55 vol %. Additionally or alternatively, the percentage of micropores in the total pore volume in the activated carbon sorbent can be typically no more than about 70 vol %, more typically no more than about 65 vol %, more typically no more than about 60 vol %, or even more typically no more than about 55 vol % micropores in the total pore volume.

In embodiments, the PFAS sequestration pore volume percent of the total pore volume in the sorbent, with pores having a pore size ranging from about 7 Å to about 26 Å, can range typically from about 25 vol % to about 50 vol %, more typically from about 28 vol % to about 45 vol %, or more typically from about 30 vol % to about 42 vol %. Additionally or alternatively, the PFAS sequestration pore volume out of the total pore volume can be typically greater than about 25 vol %, more typically greater than about 28 vol %, more typically greater than about 30 vol %, more typically greater than about 32 vol %, more typically greater than about 34 vol %, more typically greater than about 36 vol %, more typically greater than about 38 vol %, or more typically greater than about 40 vol %.

Additionally or alternatively, the PFAS sequestration pore volume out of the total pore volume can be typically no more than about 50 vol %, more typically no more than about 48 vol %, more typically no more than about 46 vol %, more typically no more than about 44 vol %, or more typically no more than about 42 vol %.

In embodiments, the volume percent of small mesopores out of the total pore volume in the activated carbon sorbent 156 can be typically from about 15 vol % to about 40 vol %, more typically from about 20 vol % to about 35 vol %, or more typically from about 25 vol % to about 35 vol %. Additionally or alternatively, the volume percent of small mesopores out of the total pore volume in the sorbent can be typically greater than about 15 vol %, more typically greater than about 20 vol %, more typically greater than about 25 vol %, or even more typically greater than about 30 vol %. Additionally or alternatively, the volume percent of small mesopores out of the total pore volume in the sorbent can be typically no more than about 40 vol %, more typically no more than about 38 vol %, more typically no more than about 36 vol %, or more typically no more than about 34 vol %.

In embodiments, the volume percent of large mesopores out of the total pore volume in the activated carbon sorbent can be typically from about 5 vol % to about 25 vol %, more typically from about 7 vol % to about 20 vol %, or more typically from about 8 vol % to about 18 vol %. Additionally or alternatively, the volume percent of large mesopores out of the total pore volume can be typically greater than about 5 vol %, more typically greater than about 6 vol %, more typically greater than about 8 vol %, more typically greater than about 10 vol %, more typically greater than about 12 vol %, or more typically greater than about 14 vol %. Additionally or alternatively, the volume percent of large mesopores out of the total pore volume can be typically no more than about 25 vol %, more typically no more than about 22 vol %, more typically no more than about 20 vol %, or more typically no more than about 18 vol %.

In embodiments, the volume percent of macropores out of the total pore volume in the activated carbon sorbent having a pore size from about 500 Å to about 1,000 Å can range typically from greater than 0 vol % to no more than about 5 vol %. In embodiments, the volume percent of macropores out of the total pore volume in the activated carbon sorbent can be typically no more than about 4 vol %, more typically no more than about 3 vol %, more typically no more than about 2 vol %, or more typically no more than about 1 vol %.

In embodiments, at least about 70% of the pores typically have a pore size of no more than about 500 Å. Additionally or alternatively, typically at least about 75%, more typically at least about 80%, or more typically at least about 85% of the pores have a pore size of no more than about 500 Å.

The spherical granular activated carbon sorbent particulates 156 or activated carbon sorbent can have an iodine number of typically between about 800 mg/g to about 1200 mg/g. In embodiments, the iodine number can be typically at least about 900 mg/g, more typically at least about 925 mg/g, more typically at least about 950 mg/g, more typically at least about 975 mg/g, more typically at least about 1000 mg/g, more typically at least about 1025 mg/g, more typically at least about 1050 mg/g, more typically at least about 1075 mg/g, or more typically at least about 1100. In embodiments, the iodine number can commonly be no more than about 1150 mg/g, commonly no more than about 1125 mg/g, and commonly no more than about 1100 mg/g.

The H₂S capacity of the activated carbon sorbent 156 can be between about 0.20 g/cc to about 0.50 g/cc. In embodiments, the H₂S capacity can be at least about 0.20 g/cc, at least about 0.25 g/cc, at least about 0.30 g/cc, at least about 0.35 g/cc, at least about 0.40 g/cc, or at least about 0.45 g/cc. Additionally or alternatively, in embodiments, the H₂S capacity can be commonly no more than about 0.50 g/cc, or commonly no more than about 0.45 g/cc.

The H₂S loading of the activated carbon sorbent 156 can be between about 50 wt % to about 100 wt %. More commonly, the H₂S loading can be between about 55 wt % to about 100 wt % or between about 56 wt % to about 100 wt %. More commonly, the H₂S loading can be at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, or at least about 100 wt %.

Additives can be incorporated into the spherical granular activated carbon particulates or activated carbon sorbent 156 to provide even more enhanced physical properties. For example, the additives can include iron sulfide compounds, metal oxides (such as magnesium oxide (MgO), calcium oxide (CaO), aluminum oxide (Al₂O₃), and activated alumina goethite (FeO(OH)), cationic minerals (catalysts), super oxidants (such as, but not limited to, permanganates and persulfates), and metal hydroxides and combinations thereof, among others. The additives may be added during feed preparation steps, during activation, and/or post activation. When metal oxide is added, the homogenized feed mixture typically comprises at least about 0.05, more typically at least about 0.15, and more typically at least about 0.5 wt. % (dry basis) metal oxide but typically no more than about 7, more typically no more than about 8, and more typically no more than about 10 wt. % (dry basis) metal oxide. When super oxidant is added, the homogenized feed mixture typically comprises at least about 0.01, more typically at least about 0.05, more typically at least about 0.15, and more typically at least about 0.5 wt. % (dry basis) metal oxide but typically no more than about 7, more typically no more than about 8, and more typically no more than about 10 wt. % (dry basis) super oxidant.

Spherical granular activated carbon particulates or activated carbon sorbent 156 can have a butane activity (measured by ASTM D₅₇₄₂) of between about 18 wt % to about 40 wt %, or more commonly between about 20 wt % to about 32 wt %. More commonly, the butane activity can be at least about 20 wt %, at least about 22 wt %, at least about 24 wt %, at least about 26 wt %, at least about 28 wt %, at least about 30 wt %, or at least about 32 wt %.

The spherical granular activated carbon sorbent particulates 156 or activated carbon sorbent can have a carbon tetrachloride capacity of at least about 45 wt % to about 90 wt % and more typically of at least about 50 wt % to about 80 wt %. More commonly, the carbon tetrachloride capacity can be at least about 50 wt %, at least about 55 wt %, at least about 60 wt %, at least about 65 wt %, at least about 70 wt %, at least about 75 wt %, or at least about 80 wt % carbon tetrachloride capacity. The spherical granular activated carbon particulates 156 can have a butane working capacity (measured by ASTM D₅₂₂₈) of between about 5 wt % to about 20 wt %. More commonly, the butane working capacity can be at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, or at least about 20 wt %.

Spherical granular activated carbon particulates or activated carbon sorbent 156 can have an acetone adsorption isotherm (at 25° C.) of about 40 wt % to about 50 wt %. More commonly, the acetone adsorption capacity can be between about 41 wt % to about 49 wt %, between about 42 wt % to about 48 wt %, between about 42 wt % to about 47 wt %, or between about 43 wt % to about 46 wt %.

Spherical granular activated carbon particulates or activated carbon sorbent 156 can have an MEK adsorption isotherm (at 25° C.) of about 30 wt % to about 50 wt %. More commonly, the MEK adsorption capacity can be between about 30 wt % to about 48 wt %, between about 31 wt % to about 47 wt %, between about 32 wt % to about 46 wt %, between about 33 wt % to about 45 wt %, between about 34 wt % to about 44 wt %, or between about 35 wt % to about 43 wt %.

Spherical granular activated carbon particulates or activated carbon sorbent 156 can have a toluene adsorption isotherm (at 25° C.) of about 80 wt % to about 99 wt %. More commonly, the toluene adsorption capacity can be at least about 80 wt %, at least about 81 wt %, at least about 82 wt %, at least about 83 wt %, at least about 84 wt %, at least about 85 wt %, at least about 86 wt %, at least about 87 wt %, at least about 88 wt %, at least about 89 wt %, at least about 90 wt %, at least about 91 wt %, at least about 92 wt %, at least about 93 wt %, at least about 94 wt %, at least about 95 wt %, at least about 96 wt %, at least about 97 wt %, at least about 98 wt %, or at least about 99 wt %.

Spherical granular activated carbon particulates or activated carbon sorbent 156 can have a limonene adsorption isotherm (at 25° C.) of about 20 wt % to about 50 wt %. More commonly, the limonene adsorption capacity can be between about 21 wt % to about 49 wt %, between about 22 wt % to about 48 wt %, between about 23 wt % to about 47 wt %, between about 24 wt % to about 46 wt %, between about 25 wt % to about 45 wt %, between about 26 wt % to about 44 wt %, between about 27 wt % to about 43 wt %, between about 28 wt % to about 42 wt %, between about 29 wt % to about 41 wt %, between about 29 wt % to about 40 wt %, between about 29 wt % to about 39 wt %, or between about 29 wt % to about 38 wt %. More commonly, the limonene adsorption capacity can be at least about 25 wt %, at least about 26 wt %, at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, at least about 49 wt %, or at least about 50 wt %.

The spherical granular activated carbon sorbent particulates 156 or activated carbon sorbent can have an apparent density (in grams per cubic centimeter) of between about 0.30 g/cc to about 0.60 g/cc. More commonly, the apparent density can be between 0.30 g/cc to about 0.55 g/cc, more commonly between about 0.35 g/cc to about 0.50 g/cc, or more commonly between about 0.36 g/cc to about 0.43 g/cc. In embodiments, the apparent density can be typically at least about 0.30 g/cc, more typically at least about 0.31 g/cc, more typically at least about 0.32 g/cc, more typically at least about 0.33 g/cc, more typically at least about 0.34 g/cc, more typically at least about 0.35 g/cc, more typically at least about 0.36 g/cc, more typically at least about 0.37 g/cc, more typically at least about 0.38 g/cc, more typically at least about 0.39 g/cc, more typically at least about 0.40 g/cc, more typically at least about 0.41 g/cc, more typically at least about 0.42 g/cc, more typically at least about 0.43 g/cc, more typically at least about 0.44 g/cc, more typically at least about 0.45 g/cc, more typically at least about 0.46 g/cc, more typically at least about 0.47 g/cc, more typically at least about 0.48 g/cc, more typically at least about 0.49 g/cc, or more typically at least about 0.50 g/cc. In embodiments, additionally or alternatively, the apparent density can be commonly no more than about 0.60 g/cc, commonly no more than about 0.59 g/cc, commonly no more than about 0.58 g/cc, commonly no more than about 0.57 g/cc, commonly no more than about 0.56 g/cc, commonly no more than about 0.55 g/cc, commonly no more than about 0.54 g/cc, commonly no more than about 0.53 g/cc, commonly no more than about 0.52 g/cc, commonly no more than about 0.51 g/cc, or commonly no more than about 0.50 g/cc. In embodiments, the apparent density can be commonly no more than about 0.45 g/cc.

Spherical granular activated carbon particulates or activated carbon sorbent 156 can adsorb various PFAS, or “forever chemicals” such as, but not limited to, perfluorooctanoic acid (PFOA), perfluorooctanesulfonic acid (PFOS), and perfluorobutanesulfonic acid (PFBS).

In embodiments where the contaminants are per- and poly-fluoroalkyl substances, the sequestration pore size can be from about 7 Å to about 26 Å, or about 1 to about 2 times the molecular diameter of the target contaminant. In embodiments where the contaminants are per- and poly-fluoroalkyl substances, the transport pore size can be about 2 to about 10 times the molecular diameter of the target contaminant.

In embodiments, the activated carbon sorbent 156 can treat water with contaminants such as, but not limited to, per- and poly-fluoroalkyl substances. The water can have a concentration of per- and poly-fluoroalkyl substances from typically about the maximum concentration level up to about 500,000 ppt, more typically from about 2 ppt to about 500,000 ppt, or even more typically from about 3 ppt to about 5,000 ppt. In embodiments, additionally or alternatively, the water can have a concentration of per- and poly-fluoroalkyl substances typically of at least about maximum contaminant level, more typically of at least about 2 ppt, or more typically at least about 4 ppt. Additionally or alternatively, the water can have a concentration of per- and poly-fluoroalkyl substances of typically no more than about 500,000 ppt, more typically no more than about 100,000 ppt, more typically no more than about 5,000 ppt, more typically no more than about 4,500 ppt, more typically no more than about 4,000 ppt, more typically no more than about 3,500 ppt, more typically no more than about 3,000 ppt, more typically no more than about 2,500 ppt, more typically no more than about 2,000 ppt, more typically no more than about 1,500 ppt, or more typically no more than about 1,000 ppt. The activated carbon sorbent 156 can reduce the concentration of per- and poly-fluoroalkyl substances down concentration levels of no more than about 4 ppt concentration after treatment with the sorbent. In embodiments, the activated carbon sorbent 156 can entrap the per- and poly-fluoroalkyl substances down to concentrations of no more than about 4 ppt after sorbent treatment.

In embodiments, the PFAS sequestration pore volume in the activated carbon sorbent or spherical granular activated carbon sorbent particulates 156, with pore size from about 7 Å to about 26 Å, can be typically from about 0.15 cc/g to about 0.28 cc/g, more typically from about 0.17 cc/g to about 0.25 cc/g, or more typically from about 0.19 cc/g to about 0.23 cc/g. Additionally or alternatively, the PFAS sequestration pore volume can be typically greater than about 0.16 cc/g, more typically greater than about 0.18 cc/g, more typically greater than about 0.20 cc/g, more typically greater than about 0.22 cc/g, or more typically greater than about 0.24 cc/g. Additionally or alternatively, the PFAS sequestration pore volume can be typically less than about 0.30 cc/g, more typically less than about 0.28 cc/g, more typically less than about 0.26 cc/g, or more typically less than about 0.24 cc/g.

As can be seen from FIG. 1, the process is free of pre-oxidation before the thermally setting and thermally charring stage.

### EXPERIMENTAL

The following examples are provided to illustrate certain embodiments of the disclosure and are not to be construed as limitations on the disclosure, as set forth in the appended claims. All parts and percentages are by weight unless otherwise specified.

The uniqueness of making activated carbon from different raw materials, specifically reclaimed bituminous fines through multiple washing, drying and grinding steps is investigated. One step is to carefully control the thermoplastic/free swelling (“coking”) properties of bituminous coal to enhance the development of pore structure and create microstructure in the coal particles to enhance the contaminant transport and sequestration into the carbon pores while reducing non-adsorption contributing interparticle void space within the granules. The ability to form a thermoplastic/free swelling material can allow for the primary coal particles to coalesce to a certain degree and reduce interparticle void space while forming the desired intraparticle pore structure. Whereas prior art uses a pre-charring oxidization coal step to minimize coking, the method of this disclosure does not employ pre-oxidation and instead takes advantage of well-controlled coking/plasticization/charring of the fine purified coal particle to create unique intra-particle and intra-granule structure/chemistry properties. Granules with high uniformity and high aspect ratio (width to length) are formed through assembling and densifying of coal particles with a green strength binder and the activation binder in the pin mixer. The unique resultant spherical shape creates benefits in use, such as reducing the particle abrasion and operating pressure drop in the column and vessel applications. The tuned surface structure and carbon property of the finished activated granules provide enhanced and efficient contaminant removal.

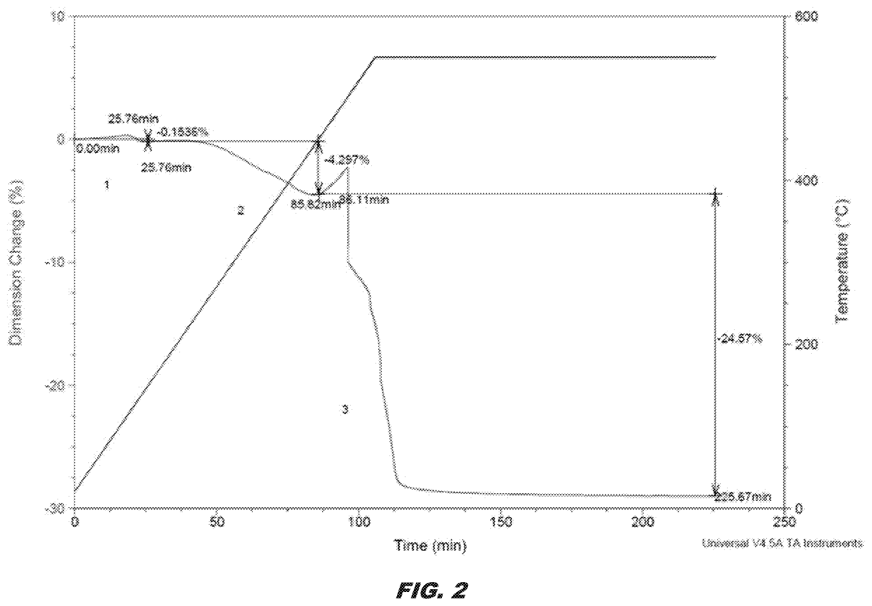

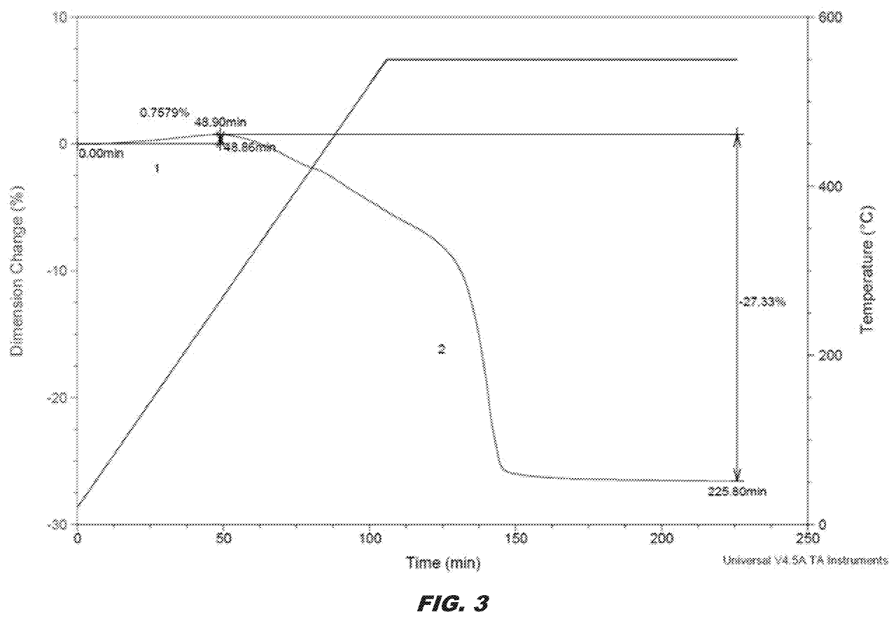

As shown in FIG. 2, the purified coal feed material (before shaping and pin mixing) shows an expansion of about 2.5% at temperature of 400-450° C. under nitrogen. As shown in FIG. 3 (post shaping), a pin mixed 2×6 granule (before charring and activation) shows reduced expansion to 0.76% at temperature ~265° C. under nitrogen, indicating better control of the coking step and resultant plastic properties of bituminous coal. The careful control of plasticization/liquefaction/coking of the purified coal feed material can be important to creating the GAC porosity infrastructure and structural hardness for high contaminant removal performance.

Table 1 below shows the properties of spherical granular activated carbon particulates manufactured using the process of the present disclosure.

TABLE 1

| | Industry Standard | Novel |
|---|---|---|
| | 12 × 40 | 12 × 40 |
| GAC | Bituminous GAC | Bituminous GAC |
| Sphericity | 0.85 | 0.95 |
| Aspect Ratio (e.g., | 0.7 | 0.8 |
| width/length - closer to | | |
| 1.0 equates to more | | |
| sphericity) | | |
| Dustiness (wt %) | 0.2% | 0.1% |
| Ball Pan Hardness (%) | 95 | 95 |
| Abrasion Number (%) | 87 | 85 |
| Iodine Number (mg/g) | 1000 | 1000 |
| Micropore volume (cc/g) | 0.33 | 0.38 |
| Mesopore volume (cc/g) | 0.21 | 0.25 |
| Particle Density (g/cc) | 0.97 | 0.95 |

A series of experiments were performed to evaluate theoretical pressure drop from the improved sphericity of the spherical granular activated carbon particulates of the present disclosure. The Kozeny-Carman equation which models pressure drop during laminar fluid flow through a packed column is used to approximate the impact of sphericity and on pressure drop.

$$\frac{Δ P}{L} = \frac{180 μ}{{φ}^{2} {D}_{p}^{2}} \frac{{( 1 - ε )}^{2}}{{ε}^{3}} {μ}_{s}$$

$$\frac{Δ P}{L} = pressure drop$$

$$μ = fluid viscosity$$

$$ϕ = sphericity$$

$$ε = void volume$$

$${D}_{P} = partical diameter$$

$${μ}_{s} = superficial velocity$$

An increase in sphericity from 0.85 to 0.95 can be anticipated to decrease pressure drop by approximately 20%. Alternatively, a more spherical particle can be used to achieve the same pressure drop with a smaller particle thereby improving adsorption kinetics and potential adsorption capacity through increased accessible pore volume and external surface area. For example, when sphericity is increased from 0.85 to 0.95, a particle size can be decreased by about 11% while maintaining the same pressure drop.

In a further series of experiments, the adsorption capacity of the spherical granular activated carbon particulates for Taste and Odor Molecules and Total Organic Carbon (TOC) was determined. As shown in Table 2 below, the novel bituminous GAC spherical granular activated carbon particulates outperform industry standard bituminous GAC by 7-66% across the board for all constituents in four different water sources. The lower performance factor indicates lower carbon dosage required to achieve the targeted removal performance.

TABLE 2

| | | Comparative Performance Factors | | |
|---|---|---|---|---|
| | | $( \frac{wt . carbon of interest}{wt . reference carbon} required to reach target conc . )$ | | |
| | | Total Organic | | Geosmin |
| | | Carbon (TOC) | Methylisoborneol | (GSM) |
| | | [20% | (MIB) | [90% |
| Waters | Carbon | removal] | [70% removal] | removal] |
| Synthetic | Industry | 1.00 | 1.00 | 1.00 |
| water | Bituminous | | | |
| (TOC = 6 | GAC | | | |
| ppm) | Novel | 0.73 | 0.66 | 0.51 |
| | Bituminous | | | |
| | GAC | | | |
| City in | Industry | 1.00 | 1.00 | 1.00 |
| Ohio | Bituminous | | | |
| (TOC = | GAC | | | |
| 9.1 ppm) | Novel | 0.47 | 0.56 | 0.48 |
| | Bituminous | | | |
| | GAC | | | |
| City in | Industry | 1.00 | 1.00 | 1.00 |
| Texas | Bituminous | | | |
| (TOC = | GAC | | | |
| 7.5 ppm) | Novel | 0.44 | 0.78 | 0.57 |
| | Bituminous | | | |
| | GAC | | | |
| City in | Industry | 1.00 | 1.00 | 1.00 |
| Illinois | Bituminous | | | |
| (TOC = | GAC | | | |
| 5.6 ppm) | Novel | 0.55 | 0.93 | 0.58 |
| | Bituminous | | | |
| | GAC | | | |

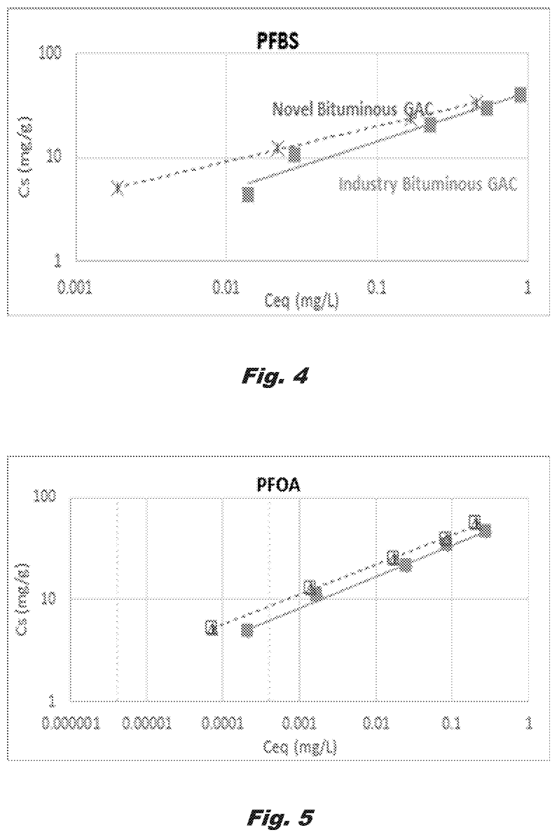

In a series of experiments, the capacity of the spherical granular activated carbon particulates for Per and Polyfluoroalkyl Substances (PFAS) was evaluated. FIGS. 4 and 5 show that the spherical granular activated carbon particulates or “novel” bituminous GAC single-in a solute isotherm in synthetic groundwater outperformed the industry bituminous GAC in adsorbing both PFBS and PFOA.

In a series of experiments, the kinetics of adsorption for the bituminous novel GAC was evaluated. As shown in Table 3, once particle size is controlled, tuning of carbon's surface/pore characteristics can allow for faster adsorption kinetics of the bituminous spherical granular activated carbon particulates for dilute Taste & Odor compounds and greater adsorption capacity for Total Organic Carbon (TOC). Compared to conventional bituminous activated carbon (“Industry”), this result is likely a result of increased sequestration pores in the novel bituminous GAC and/or differences in the carbon microstructure.

TABLE 3
Ratio of Industry/Novel adsorption capacity
at 10 minutes to 24 hours (Higher is Better)

| Constituent | Industry | Novel |
|---|---|---|
| MIB | 0.4 | 0.7 |
| GSM | 0.4 | 0.6 |
| TOC | 0.5 | 0.5 |

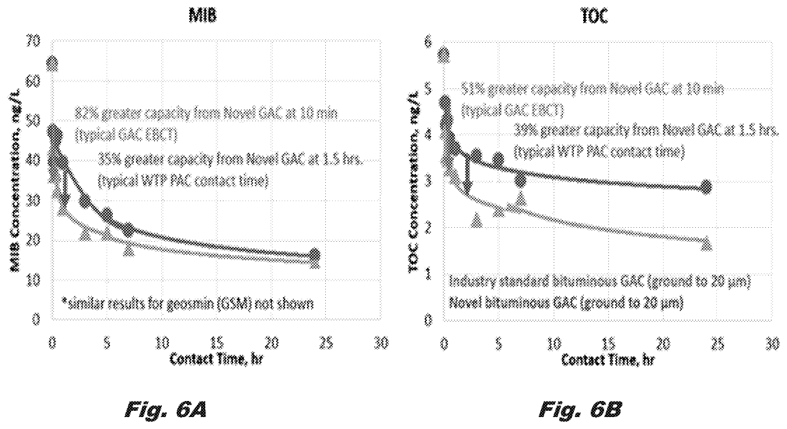

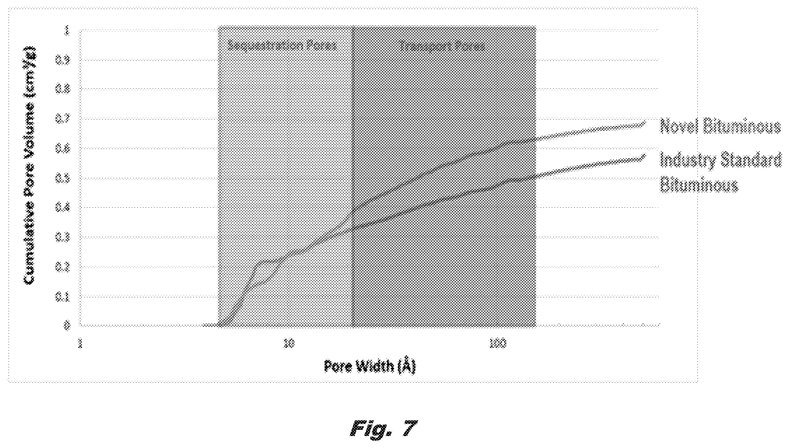

Referring to FIG. 6A, comparing the upper curve corresponding to industry standard bituminous GAC to the lower curve corresponding to the novel GAC of the present disclosure shows that the novel bituminous GAC of the present disclosure has an approximate 82% greater capacity for both 2-methylisoborneol (MIB) and geosmin after 10 minutes of contact (typical GAC empty bed contact time (EBCT) and 35% greater capacity after 1.5 hours of contact (typical water treatment plant (WTP) powdered activated carbon (PAC) contact time.

Referring to FIG. 6B, comparing the upper curve corresponding to industry standard bituminous GAC to the lower curve corresponding to the novel bituminous GAC of the present disclosure shows that the novel bituminous GAC of the present disclosure has an approximate 51% greater capacity for total organic carbon (TOC) after 10 minutes of contact (typical GAC empty bed contact time (EBCT) and 39% greater capacity after 1.5 hours of contact (typical water treatment plant (WTP) powdered activated carbon (PAC) contact time. FIG. 7 depicts cumulative pore volume comparison between novel and industry standard bituminous GAC as measured by nitrogen adsorption using Micromeritics 3Flex and modeled by Density Functional Theory. As will be appreciated, sequestration pores have a pore diameter up to 20 Å while transport pores have a pore diameter ranging from about 20 to 150 Å. FIG. 7 shows that the novel bituminous GAC of the present disclosure has a higher cumulative pore volume of sequestration pores and a markedly higher cumulative pore volume of transport pores.

A series of experiments was conducted to determine levels of water-extractable arsenic in novel bituminous GAC produced from purified activated carbon compared to industry standard bituminous GAC. As shown in Table 4, the use of a purified coal as feedstock for preparation the novel bituminous GAC results in a 45-84% reduction in extractable Arsenic. Also included was a sample of Novel Bituminous GAC with the addition magnesium oxide which resulted in non-detect levels of leachable arsenic. As will be appreciated, lower Arsenic in the water concentration is required for drinking water applications.

TABLE 4

| | Arsenic water concentration after |
|---|---|
| | 20 wt % GAC is exposed to DI water for |
| | 72 hours filtered to 0.45 um and |
| Carbon | analyzed by ICP |
| Industry Bituminous GAC 1 | 84 |
| Industry Bituminous GAC 2 | 97 |
| Novel Bituminous GAC 1 | 46 |
| Novel Bituminous GAC 2 | 15 |
| Novel Bituminous GAC 1 + | <1 |
| 0.5% MgO | |

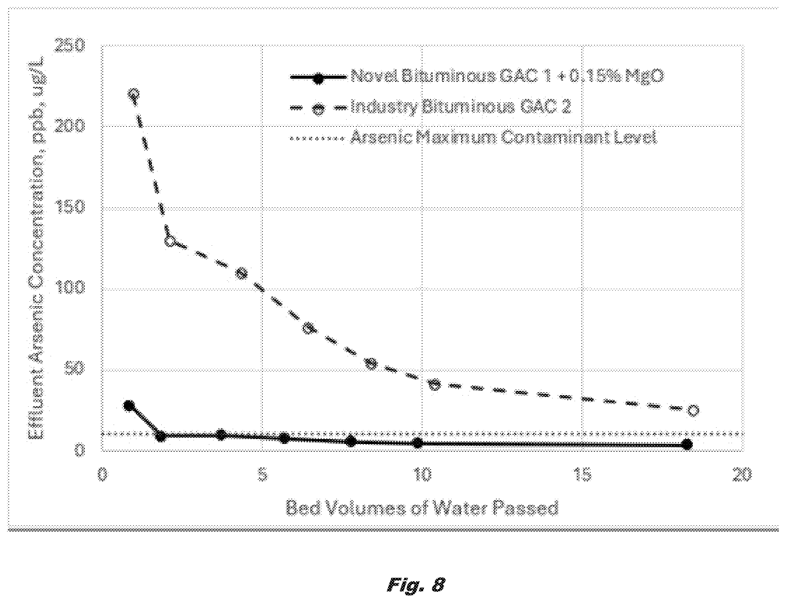

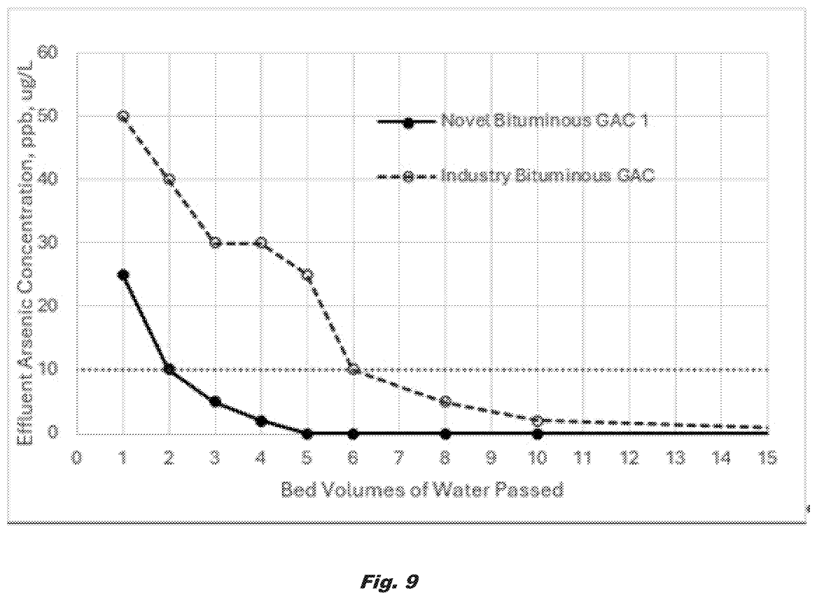

To simulate startup at a drinking water treatment facility, GAC was loaded into a 2.5 cm X15 cm column, filled with tap water and allowed to soak for 24 hours. After 24 hours, tap water was pumped through the column at an empty bed contact time of 10 minutes. Effluent water samples were collected and analyzed for arsenic with either a Hach arsenic test kit (FIG. 8) or by ICP (FIG. 9). FIG. 8 shows that the Novel Bituminous GAC made using purified coal product as its feedstock resulted in a 3× reduction in the bed volumes required to achieve effluent arsenic concentrations of less than the 10 μg/L Maximum Contaminant Level. FIG. 9 shows Novel Bituminous GAC made using purified coal product amended with magnesium oxide as its feedstock achieved effluent arsenic concentrations below the 10 μg/L Maximum Contaminant Level in 2 bed volumes whereas the industry bituminous GAC was still above 10 μg/L after 19 bed volumes.

Finally, a series of experiments were performed to compare the acid gas capacity of the novel modified bituminous GAC compared to industry standard lignite and bituminous GAC. As can be seen in Table 5 below, both novel GAC formulations have a higher H₂S capacity and loading compared to the industry standard lignite and bituminous GAC with comparable BPH to the industry standard bituminous GAC.

TABLE 5

| | Apparent | H₂S | H₂S | Ball Pan |
|---|---|---|---|---|
| | Density | Capacity | Loading | Hardness, |
| GAC 4 × 10 Mesh | g/cc | g/cc | wt % | % |
| Industry Lignite GAC | 0.40 | 0.20 | 50 | 58 |
| Industry Bituminous GAC | 0.54 | 0.01 | 1.5 | 95 |
| Novel Bituminous GAC 3 | 0.41 | 0.23 | 56 | 91 |
| Novel Bituminous GAC 4 | 0.39 | 0.30 | 78 | 96 |

A series of experiments were performed to determine butane activity, carbon tetrachloride capacity, BET surface area, total pore volume, micropore volume, and mesopore volume for various granular activated carbons produced by methods of the present disclosure. The results are presented in Table 6.

TABLE 6
Carbon porosity and butane activity

| | | | | | | Meso- |
|---|---|---|---|---|---|---|
| | Butane | | | Total | Micro- | pore |
| | Activity | Carbon | BET | Pore | pore | Volume, |
| | wt %, | tetra- | Surface | Volume, | Volume, | cc/g |
| | ASTM | chloride | Area, | cc/g | cc/g | (20- |
| GAC | D5742 | wt % | m2/g | (<500 A) | (<20 A) | 500 A) |
| Arq | 23 | 58 | 1078 | 0.62 | 0.39 | 0.23 |
| AirLoq | | | | | | |
| 410 H2S | | | | | | |
| Arq | 24 | 61 | 1040 | 0.64 | 0.37 | 0.26 |
| CarbPure | | | | | | |
| GAC | | | | | | |
| 1240 | | | | | | |
| Arq | 25.5 | 65 | 1121 | 0.65 | 0.41 | 0.24 |
| AirLoq | | | | | | |
| 410 VOC | | | | | | |
| 1 | | | | | | |
| Arq | 28 | 71 | 1100 | 0.75 | 0.39 | 0.36 |
| AirLoq | | | | | | |
| 410 VOC | | | | | | |
| 2 | | | | | | |

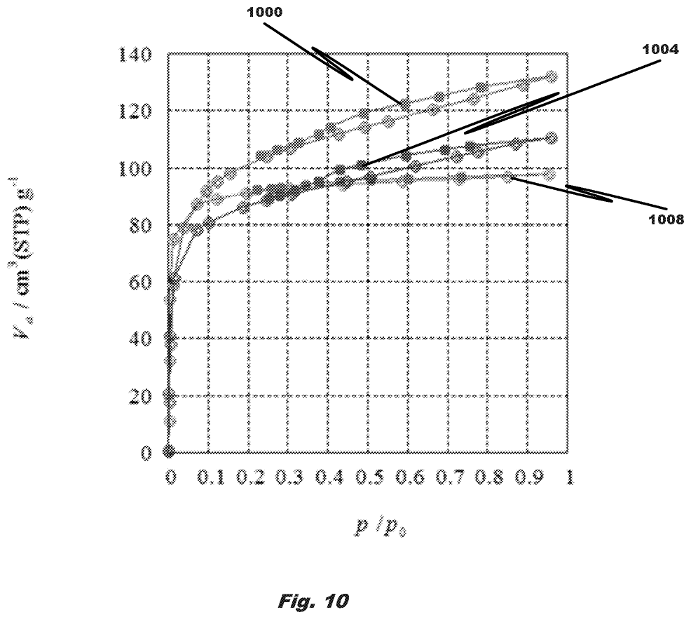

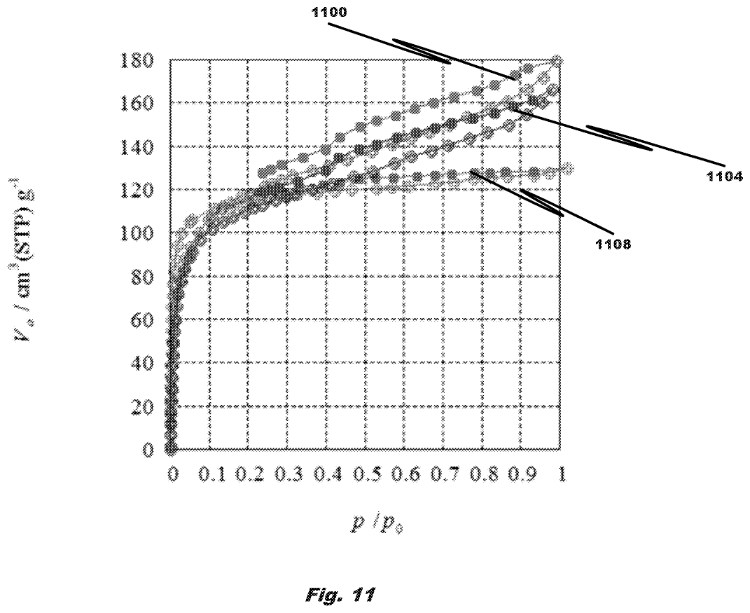

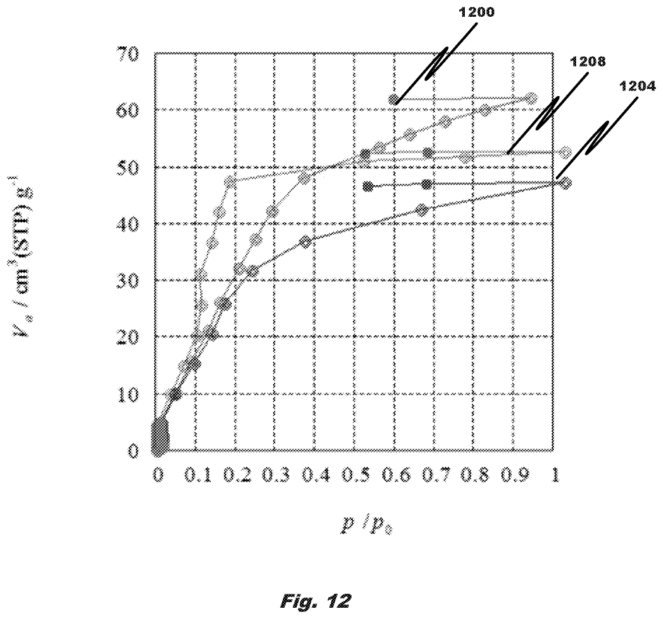

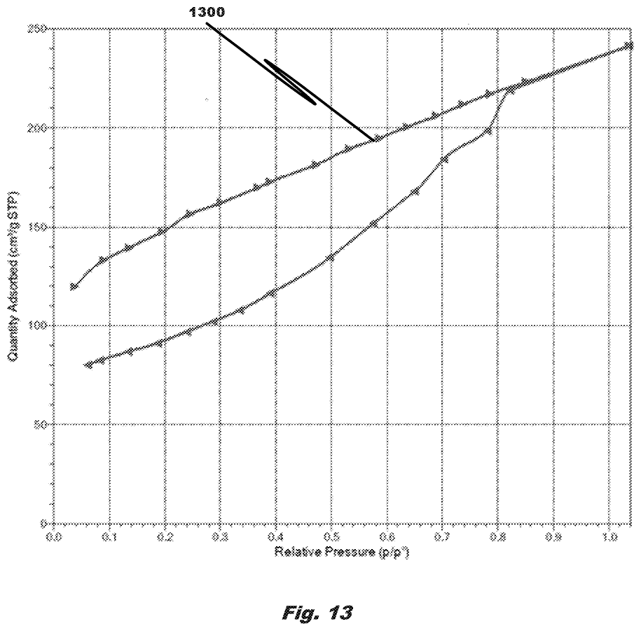

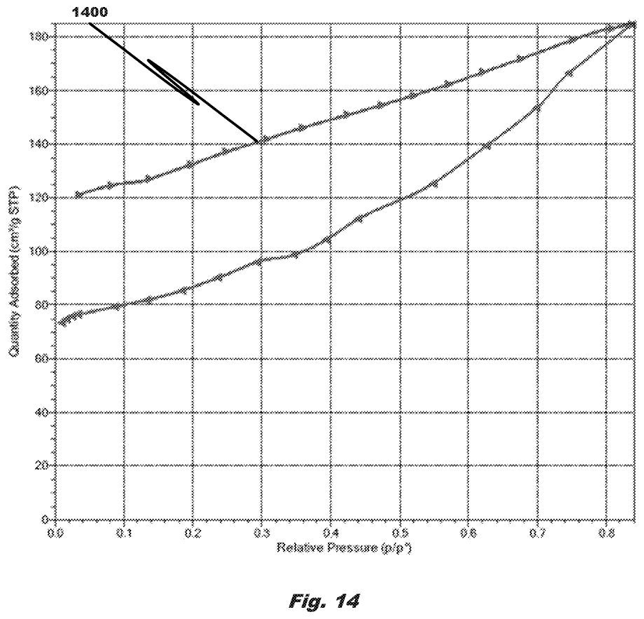

FIGS. 10 through 13 show the comparison of AirLoq VOC products (VOC 1, VOC 2, and VOC 3) and AirLog410 H₂S products (H2S 1, H2S 2, H2S 3, and H2S 4) with a coconut based 4×8 GAC regarding butane adsorption, representative VOC adsorption, H₂S adsorption, and associated carbon properties. More specifically, in FIG. 10 plot 1000 represents AirLog410 VOC1, plot 1004 represents AirLog410 H2S 1, and plot 1008 represents 4×8 GAC (made from coconut); in FIG. 11 plot 1100 represents AirLog410 VOC1, plot 1104 represents AirLog410 H2S 1, and plot 1108 represents 4×8 GAC (made from coconut); in FIG. 12 plot 1200 represents AirLog410 VOC1, plot 1204 represents AirLog410 H2S 1, and plot 1208 represents 4×8 GAC (made from coconut); in FIG. 13 plot 1300 represents the full isotherm of toluene adsorption at 25° C. for AirLoq 410 VOC1; and in FIG. 14 plot 1400 represents the full isotherm of toluene adsorption at 25° C. for 4×8 GAC (made from coconut).

FIGS. 10 through 12 show the volumetrically determined load as a function of the relative pressure.

AirLoq 410 VOC 1 outperformed coconut-based GAC by at least 10% for acetone, MEK, Toluene and Limonene adsorption, as shown in table 7 below.

TABLE 7
Comparison of carbon adsorption for butane, and representative VOCs

| | | | Butane | | | | | | | |
|---|---|---|---|---|---|---|---|---|---|---|
| | Butane | (Carbon | Working | | | | | | | |
| | Activity | Tetra- | Capacity | | | | | | | |
| Carbon for | wt %, | chloride) | wt. %, | Adsorption Isotherm at 25 C. | | | | Apparent | H2S | H2S |
| VOC & | ASTM | CTC | ASTM | Acetone, | MEK, | Toluene, | Limonene, | Density, | Capacity, | Loading, |
| Siloxanes | D5742 | wt % | D5228 | wt % | wt % | wt % | wt % | g/cc | g/cc | wt % |
| 4 × 8 GAC | 23.3 | 59.4 | 1.3 | 34 | 32 | 71 | 32 | 0.49 | 0.03 | 7% |
| (Coconut) | | | | | | | | | | |
| AirLoq410 | 23.1 | 58.9 | 7.0 | 46 | 43 | 92 | 38 | | | |
| VOC 1 | | | | | | | | | | |
| AirLoq410 | 27.6 | 70.4 | 11.6 | | | | | | | |
| VOC 2 | | | | | | | | | | |
| AirLoq410 | 29.1 | 74.2 | 15.0 | | | | | | | |
| VOC 3 | | | | | | | | | | |
| AirLoq410 | 22.8 | 58.1 | 8.6 | 43 | 35 | | 29 | 0.41 | 0.23 | 56% |
| H2S 1 | | | | | | | | | | |
| AirLoq410 | 24.1 | 61.5 | 11.2 | | | | | 0.43 | 0.32 | 75% |
| H2S 2 | | | | | | | | | | |
| AirLoq410 | 26.5 | 67.6 | 13.1 | | | | | 0.36 | 0.36 | 100% |
| H2S 3 | | | | | | | | | | |
| AirLoq410 | 28.1 | 71.7 | 15.2 | | | | | 0.36 | 0.38 | 105% |
| H2S 4 | | | | | | | | | | |

AirLoq 410 VOC 3 and AirLoq 410 H2S 4 achieved over 70 wt % CTC, and 15 wt % butane working capacity AirLoq410 H2S demonstrated high H2S adsorption capacity over 0.3 g/cc, due to higher pore volume in both micropore (for VOC adsorption) and mesopore (for H2S adsorption) range, as shown in Table 8 below.

### Table 8 Carbon Properties

| | Iodine | BET | Micro | Meso |
|---|---|---|---|---|
| Carbon for VOC & | Number, | Area | Pores | Pores |
| Siloxanes | mg/g | m2/g | cc/g | cc/g |
| 4 × 8 GAC (Coconut) | 1133 | 1244 | 0.49 | 0.06 |
| AirLog410 VOC 1 | | 984 | 0.37 | 0.17 |
| AirLog410 VOC 2 | 1023 | 1126 | 0.41 | 0.27 |
| AirLog410 VOC 3 | | 1155 | 0.42 | 0.25 |
| AirLog410 H2S 1 | 1064 | 1078 | 0.39 | 0.23 |
| AirLog410 H2S 2 | 932 | 959 | 0.35 | 0.25 |
| AirLog410 H2S 3 | 982 | 1048 | 0.37 | 0.36 |
| AirLog410 H2S 4 | 1008 | 1170 | 038 | 0.50 |

AirLoq410 products with uniformly spherical shape offering lower pressure drop and comprising a tailored pore structure and optimized surface oxidation chemistry, exhibit enhanced performance in hydrogen sulfide (H₂S) removal while simultaneously providing maximized adsorption capacities in a broad spectrum of volatile organic compounds (VOCs). This dual-function capability surpasses the performance of industrial standard lignite-based granular activated carbon in H₂S removal and coconut-based GAC in VOC adsorption. Since the oxidation catalyst is incorporated before the activation, unlike the post-spray or the impregnated carbon media, AirLoq 410 will not cause bricking, potential bed heat up, or spontaneous combustion. All AirLoq 410's pore volume and surface area are available for storing sulfur converted from the H₂S adsorbed and for the adsorption of any additional volatile organic compounds that may exist in the gas stream.

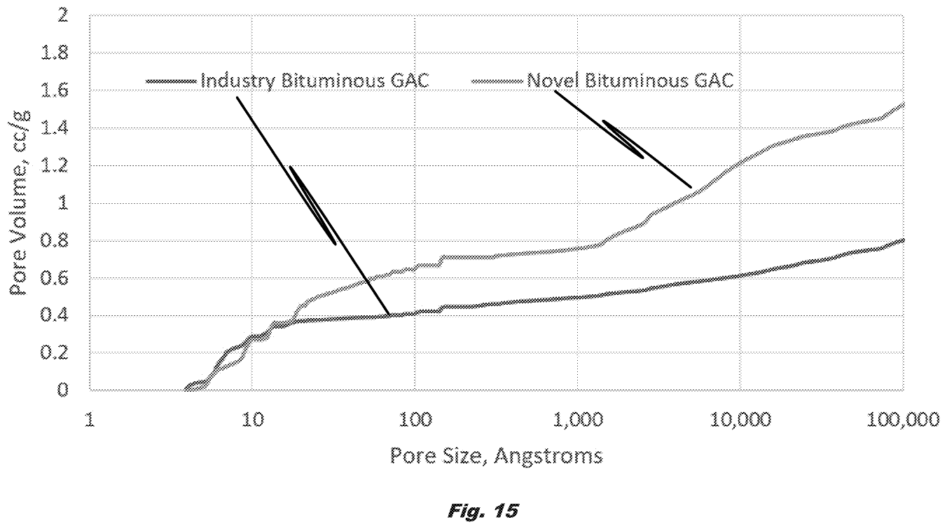

A novel GAC produced according to methods of the present disclosure showed a 200% increase in transport small mesopores and a 291% increase in intragranular channels compared to an industry standard bituminous GAC as shown in Table 9 and FIG. 15.

TABLE 9
GAC Properties

| | | | Industry | Novel |
|---|---|---|---|---|
| | | | Bitu- | Bitu- |
| | | | minous | minous |
| Property | Method | Unit | GAC | GAC |
| Apparent Density | | g/cc | 0.59 | 0.50 |
| Ash | TGA | wt % | 5.7 | 12.5 |
| Micro + Meso | N2 | cc/g | 0.46 | 0.64 |
| Pore Volume | porosimetry | | | |
| Sequestration | N2 | cc/g | 0.37 | 0.43 |
| Micropores (0-20Å) | porosimetry | | | |
| Transport Small | N2 | cc/g | 0.05 | 0.15 |
| Mesopores (20-150Å) | porosimetry | | | |
| Large Meso and | N2 | cc/g | 0.06 | 0.08 |
| Macropores (150-1,000Å) | porosimetry | | | |

FIG. 15 shows the combined pore size distribution obtained from nitrogen and mercury intrusion porosimetry comparing an industry bituminous GAC to the novel bituminous GAC, as produced according to methods of the present disclosure.

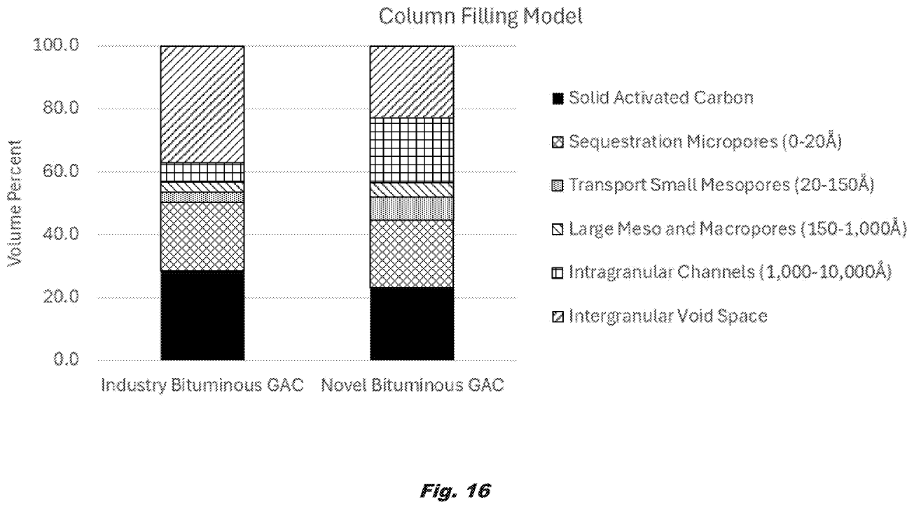

The properties of the novel GAC were then converted to percent volume fill, as shown in Table 10 and FIG. 16, to visualize how these properties translate into field vessel applications. The values were calculated based on GAC apparent density, the pore volumes from N₂ porosimetry and Hg intrusion, and assumptions about the density of the solid portion of the activated carbon (assuming the density of the ash to be the density of SiO₂, the most dominant ash mineral, and the remaining solid to have the density of predominantly amorphous carbon). These values translate to a 153% increase in vessel volume occupied by transport small mesopores.

TABLE 10
Volume Composition of a Vessel Filled with GAC

| | | Industry | Novel |
|---|---|---|---|
| | | Bituminous | Bituminous |
| Composition | unit | GAC | GAC |
| Sequestration | vol % | 21.8 | 21.5 |
| Micropores | | | |
| (0-20Å) | | | |
| Transport Small | vol % | 3.0 | 7.5 |
| Mesopores | | | |
| (20-150Å) | | | |
| Large Meso and | vol % | 3.5 | 4.2 |
| Macropores | | | |
| (150-1,000Å) | | | |
| Solid Activated | vol % | 29.0 | 24.0 |
| Carbon | | | |
| Void Space | vol % | 42.8 | 42.8 |

FIG. 16 shows two GAC materials, one industry bituminous GAC and one novel bituminous GAC.

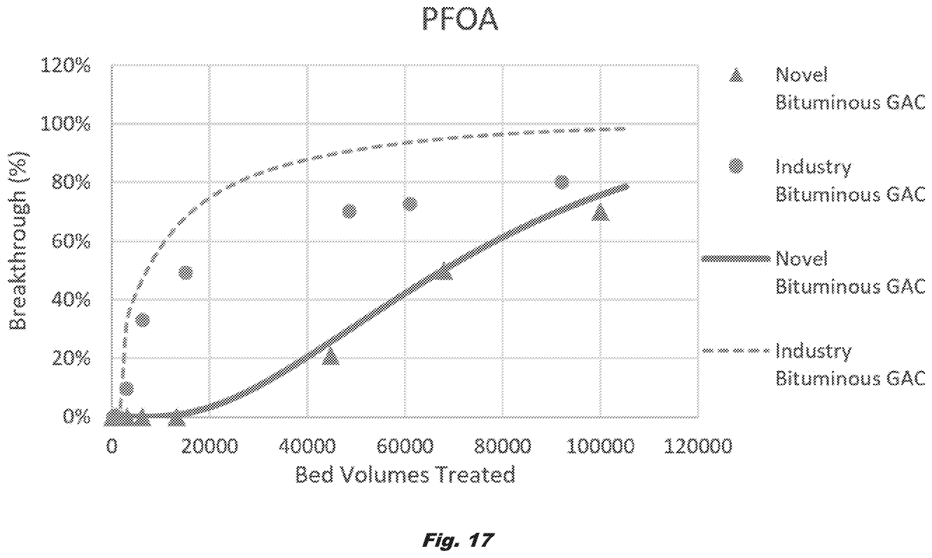

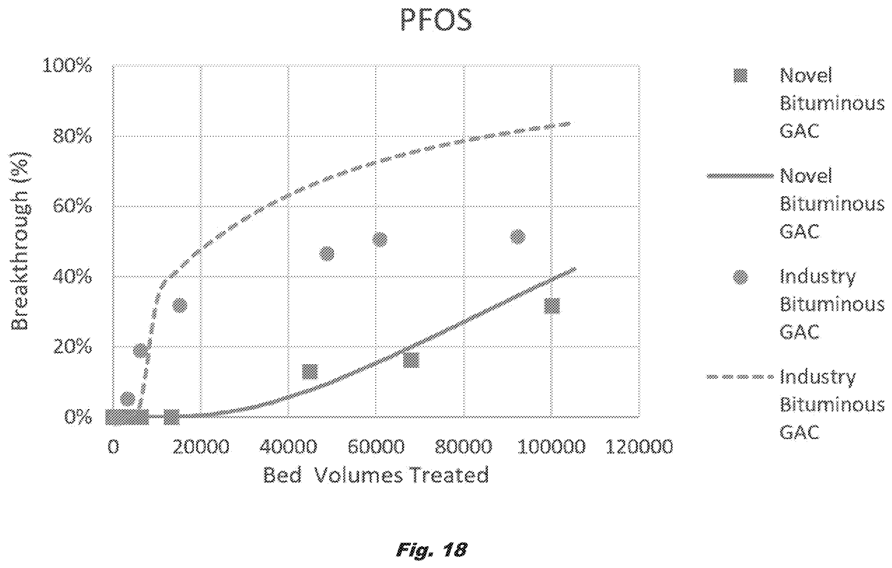

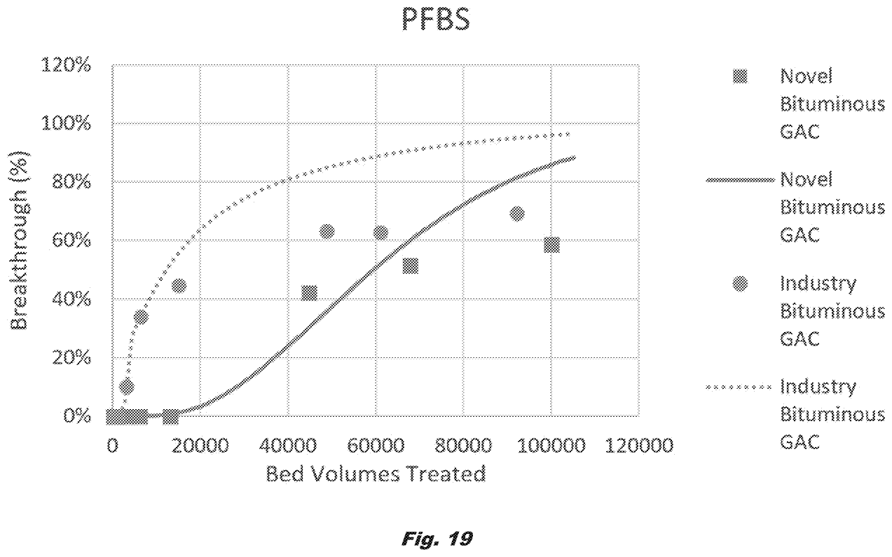

Both of these GAC materials were subjected to a Rapid Small Scale Column Test (RSSCT) designed to simulate breakthrough behavior for a system operating at a 10-minute Empty Bed Contact Time (EBCT). Breakthrough curves are shown in FIG. 17 through FIG. 19. Water used in the test was tap water from a city in Colorado spiked to approximately 100 ppt of 7 different PFAS. The percent breakthrough (effluent concentration/influent concentration) with increasing bed volume (volume of the empty vessel) treatments for three common PFAS compounds are shown, including PFOA (FIG. 17), PFOS (FIG. 18), and PFBS (FIG. 19).

The curve fits were generated with the Pore Surface Diffusion Model (PSDM) using the EPA's AdDesignS Software and a pseudo single-solute fitting approach. The model fitting approach first obtains a Freundlich K value from the bed volumes treated at 50% breakthrough (assuming Freundlich n=1). Default kinetic parameters of Surface to Pore Diffusion Flux Ratio (SPDFR) and tortuosity are set to 10-30 and 1 respectively. Then, kinetic parameters are adjusted to fit the shape of the empirical breakthrough curve by increasing SPDFR if the curve is too flat or increasing tortuosity if the curve is too steep. Modeled parameters for these two carbons can be found in Table 11. Modeling parameters show tortuosity of the Novel bituminous GAC of 1 compared to a tortuosity of 7 for the industry standard GAC. Tortuosity is the ratio of the actual tortuous diffusion path length compared to the idealized straight-line direct diffusion path. Without wishing to be bound by any theory, it is hypothesized that increasing transport small mesopore volume in the Novel Bituminous GAC can create a more direct diffusion path to adsorption sites, which can also result in a much shorter Mass Transfer Zone (MTZ).

TABLE 11
Pore Surface Diffusion Model (PSDM) fits for
FIG. 3 using the EPA's AdDesignS Model

| | | Industry | Novel |
|---|---|---|---|
| | | Bituminous | Bituminous |
| | | GAC | GAC |
| PFOA | K (L/g) | 29 | 150 |
| | SPDFR | 0 | 0 |
| | Tortuosity | 7 | 1 |
| | MTZ (m) | 21 | 5 |
| PFOS | K (L/g) | 99 | 268 |
| | SPDFR | 0 | 0 |
| | Tortuosity | 7 | 1 |
| | MTZ (m) | 24 | 5 |
| PFBS | K (L/g) | 42 | 129 |
| | SPDFR | 0 | 0 |
| | Tortuosity | 7 | 1 |
| | MTZ (m) | 16 | 4 |

Two activation levels of these novel GAC products were also subjected to a batch kinetic test. GAC products were ground to PAC (20 μm D50) for ease of dosing small quantities. Then, jars with the same dosage of PAC were put onto a rotary shaker for a variable amount of time before filtering and analyzing the filtrate for PFOA. FIG. 17 shows increasing PFOA adsorption with increasing transport small mesopore volume, where increased transport small mesopore volume increases the slope of the removal curve.

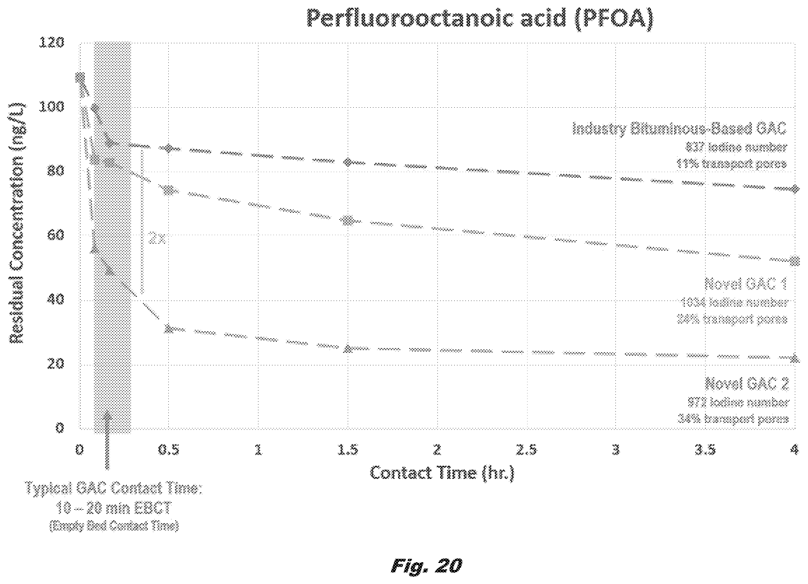

FIG. 20 shows results from batch kinetic test of three GACs, one industry bituminous-based GAC and two Novel GACs (Novel GAC 1 and Novel GAC 2) as produced with methods according to the present disclosure. The industry bituminous-based GAC had an iodine number of 837, and 11 vol % transport pores. Novel GAC 1 had an iodine number of 1034 and 24 vol % transport pores, and Novel GAC 2 had an iodine number of 972 and 34 vol % transport pores.

Without wishing to be bound by any theory, it is predicted that increased transport small mesopore volume and increased intragranular channels may also increase adsorption capacity through increased accessibility to sequestration sites and/or through increased selectivity.

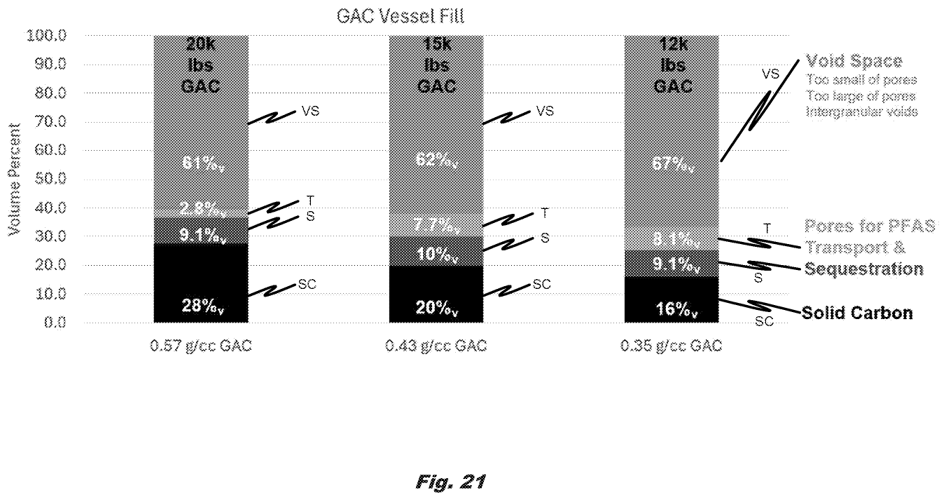

GAC is typically filled by volume and purchased by weight. Lower apparent density means that less weight of GAC is added for an individual vessel fill. The lower apparent density also typically correlates with increased activation level and subsequently increased pore volume. FIG. 21 illustrates the fill of a typical 10-foot GAC vessel for a high (0.57 g/cc), medium (0.43 g/cc), and low (0.35 g/cc) apparent density 12×40 reagglomerated bituminous GAC. Typically, as apparent density decreases, the amount of solid carbon in a vessel decreases while pore volume increases.

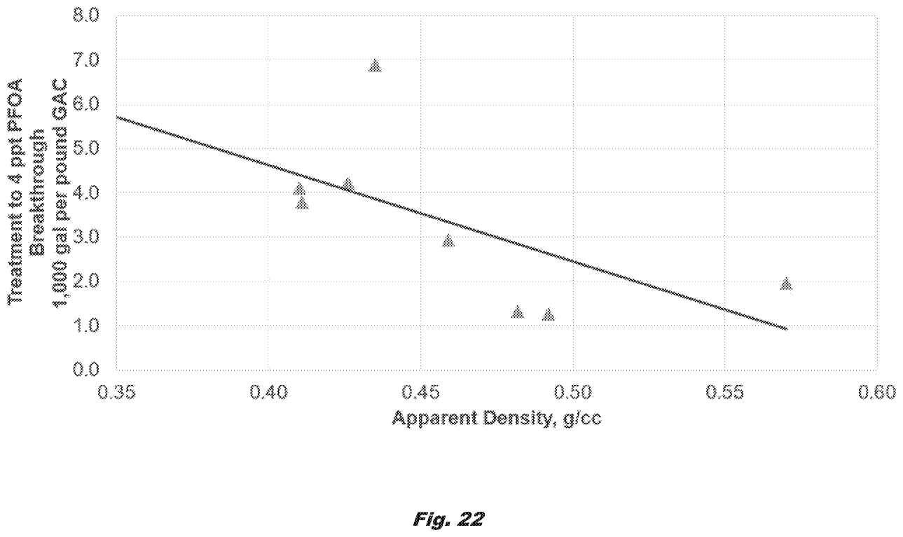

This decrease in apparent density and subsequent increase in pore volume seen in FIG. 21 can be correlated to PFAS adsorption performance in a Rapid Small Scale Column Test (RSSCT) as shown in FIG. 22. This test used pre-adsorber water collected from a Colorado surface water treatment plant containing about 20 ppt PFOA. All samples have approximately a 1,000 mg/g iodine number and are reagglomerated bituminous-based 12×40 size GACs. Without wishing to be bound by any theory, it is hypothesized that the correlation is not 1:1 because other factors, such as, but not limited to, the size distribution of the added pore volume and surface chemistry still have an influence on adsorption performance. FIG. 22 shows the adsorption performance given in 1,000 gallons of water treated to 4 ppt PFOA breakthrough as a function of GAC apparent density.

Six reagglomerated bituminous-based GAC samples were evaluated through RSSCT on a Colorado surface water and the results are shown in Table 12. Performance was quantified as the number of bed volumes of water treated before surpassing the PFOA maximum contaminant level (MCL) of 4 ppt. The novel GAC samples treated significantly more water than the industry standard GACs. These enhanced GACs can have a lower apparent density, increased PFAS sequestration pore volume (pores representing approximately 1-2× the molecular diameter of a typical 4-8 carbon chain PFAS molecule), increased small meso (transport) pore volume, and increased intragranular channels when compared to the industry bituminous-based GACs. Without wishing to be bound by any theory, it is predicted that these results indicate that properties such as, but not limited to, iodine number and micropore volume are not sufficient to differentiate GAC performance for PFAS removal.

TABLE 12
part 1:

| | Bed volumes | | | |
|---|---|---|---|---|
| | treated before | | | Total Pore |
| | PFOA | Iodine | Apparent | Volume |
| GAC | breakthrough at | number | density | (<1,000Å) |
| Description | 20% (~4 ppt) | (mg/g) | (g/cc) | (cc/g) |
| Industry | 5,200 | 1021 | 0.49 | 0.55 |
| Bituminous 1 | | | | |
| Industry | 9,300 | 1009 | 0.57 | 0.48 |
| Bituminous 2 | | | | |
| Novel | 11,200 | 1019 | 0.46 | 0.64 |
| Bituminous 1 | | | | |
| Novel | 13,000 | 995 | 0.41 | 0.73 |
| Bituminous 2 | | | | |
| Novel | 15,000 | 987 | 0.43 | 0.65 |
| Bituminous 3 | | | | |
| Novel | 25,000 | 1058 | 0.44 | 0.78 |
| Bituminous 4 | | | | |

part 2:

| | | PFAS | Small Meso | Large | Macropore |
|---|---|---|---|---|---|
| | Micro Pore | Sequestration | (Transport) | Mesopore | Volume |
| | Volume | Pore Volume | Pore Volume | Volume | (500- |
| GAC | (0-20Å) | (7-26Å) | (20-150Å) | (150- | 1,000Å) |
| Description | (cc/g) | (cc/g) | (cc/g) | 500Å) | |
| Industry | 0.39 | 0.18 | 0.09 | 0.04 | 0.03 |
| Bituminous 1 | | | | | |
| Industry | 0.38 | 0.16 | 0.06 | 0.03 | 0.01 |
| Bituminous 2 | | | | | |
| Novel | 0.41 | 0.26 | 0.16 | 0.05 | 0.02 |
| Bituminous 1 | | | | | |
| Novel | 0.40 | 0.23 | 0.19 | 0.12 | 0.01 |
| Bituminous 2 | | | | | |
| Novel | 0.37 | 0.24 | 0.21 | 0.07 | 0.00 |
| Bituminous 3 | | | | | |
| Novel | 0.41 | 0.28 | 0.24 | 0.12 | 0.01 |
| Bituminous 4 | | | | | |

Table 13 shows volume percentage calculations of the sorbents using the density of amorphous carbon (2.0 g/cc), weighted ash density (3.3 g/cc), and an average density of solid activated carbon (2.1 g/cc). Table 13 includes the volume percentages calculated as a percentage of the volume of a packed bed (vessel).

TABLE 13
part 1:

| | | | PFAS | Small Meso |
|---|---|---|---|---|
| | Total Pore | Micro Pore | Sequestration | (Transport) |
| | Volume | Volume | Pore Volume | Pore Volume |
| GAC | (<1,000Å) | (0-20Å) | (7-26Å) | (20-150Å) |
| Description | (vol %) | (vol %) | (vol %) | (vol %) |
| Industry | 27% | 19% | 9% | 4% |
| Bituminous 1 | | | | |
| Industry | 27% | 22% | 9% | 3% |
| Bituminous 2 | | | | |
| Novel | 29% | 19% | 12% | 7% |
| Bituminous 1 | | | | |
| Novel | 30% | 17% | 9% | 8% |
| Bituminous 2 | | | | |
| Novel | 28% | 16% | 10% | 9% |
| Bituminous 3 | | | | |
| Novel | 34% | 18% | 12% | 10% |
| Bituminous 4 | | | | |

part 2:

| | Large Meso | Macro Pore | Solid | |
|---|---|---|---|---|
| | Pore Volume | Volume | Activated | |
| GAC | (150-500Å) | (500-1,000Å) | Carbon | Voids |
| Description | (vol %) | (vol %) | (vol %) | (vol %) |
| Industry | 2% | 1% | 23% | 50% |
| Bituminous 1 | | | | |
| Industry | 2% | 1% | 27% | 46% |
| Bituminous 2 | | | | |
| Novel | 2% | 1% | 22% | 49% |
| Bituminous 1 | | | | |
| Novel | 5% | 1% | 19% | 51% |
| Bituminous 2 | | | | |
| Novel | 3% | 0% | 20% | 52% |
| Bituminous 3 | | | | |
| Novel | 5% | 0% | 20% | 46% |
| Bituminous 4 | | | | |

Table 14 shows volume percentage calculations of various pore sizes as a percentage of the total pore volume.

TABLE 14

| | | PFAS | | Large | |
|---|---|---|---|---|---|
| | | Seques- | Small Meso | Meso | Macro |
| | Micro | tration | (Transport) | Pore | Pore |
| | Pore | Pore | Pore | Volume | Volume |
| | Volume | Volume | Volume | (150- | (500- |
| GAC | (0-20Å) | (7-26Å) | (20-150Å) | 500Å) | 1,000Å) |
| Description | (vol %) | (vol %) | (vol %) | (vol %) | (vol %) |
| Industry | 71% | 33% | 16% | 7% | 5% |
| Bituminous 1 | | | | | |
| Industry | 79% | 33% | 13% | 6% | 2% |
| Bituminous 2 | | | | | |
| Novel | 64% | 41% | 25% | 8% | 3% |
| Bituminous 1 | | | | | |
| Novel | 55% | 32% | 26% | 17% | 2% |
| Bituminous 2 | | | | | |
| Novel | 57% | 37% | 32% | 11% | 0% |
| Bituminous 3 | | | | | |
| Novel | 53% | 36% | 31% | 15% | 1% |
| Bituminous 4 | | | | | |

The exemplary systems and methods of this disclosure have been described in relation to carbonaceous materials. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A sorbent composition comprising primarily activated carbon with an apparent density of at least about 0.30 g/cc, wherein the sorbent composition comprises small mesopores, wherein the small mesopores have a pore size ranging from about 20 Å to about 150 Å, wherein a volume of small mesopores is at least about 0.10 cc/g, wherein the sorbent composition comprises micropores, wherein the micropores have a pore size of less than about 20 Å, wherein a volume of micropores is at least about 0.35 cc/g, and wherein the sorbent comprises from about 10 vol. % to about 35 vol. % solid activated carbon.

2. The sorbent composition of claim 1, wherein at least most of the particulates of the sorbent composition have a mean and/or median sphericity in the range of from about 0.75 to about 1.0, a volume of pores having a pore size of less than about 1,000 Å is at least about 0.6 cc/g, a BET surface area of at least about 900 m²/g, and wherein the apparent density is at least about 0.35 g/cc.

3. The sorbent composition of claim 1, wherein the sorbent composition is derived from a carbonaceous feed material comprising bituminous coal, a green strength binder, and an activation binder, and wherein the carbonaceous feed material comprises at least about 70 wt. % bituminous coal on a dry weight basis.

4. The sorbent composition of claim 3, wherein the carbonaceous feed material can further comprise a sacrificial additive, wherein the sacrificial additive can comprise at least one of hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethyl-methyl cellulose, starches & other carbohydrates, xanthan gum derivatives, guar gum derivatives, hydroxypropyl guar gum, polyacrylates derivatives, acrylates/C10-C30 alkyl acrylate cross-polymer, carbomer, polyacrylate-1 cross-polymer, sugar, sugar alcohols, fatty acids, long-chain alkanes, lignosulfonates, and nanofibers, and wherein at least most of the sacrificial additive is absent from the sorbent composition.

5. The sorbent composition of claim 3, wherein the sorbent composition comprises greater than about 90 wt % of a bituminous coal, less than about 0.5 wt % of a green strength binder, and less than about 2 wt % moisture, and wherein the green strength binder comprises carboxymethyl cellulose, carboxymethylhydrocellulose, hydroxyethyl cellulose, hydroxymethyl cellulose, hydroxyethyl methyl cellulose, hydroxypropyl cellulose, hydroxypropyl methylcellulose, ethyl hydroxyethyl cellulose, methyl cellulose, ethyl cellulose, ethyl-methyl cellulose, enriched methyl-hydroxypropyl cellulose MHPC, and other cellulose derivatives, xanthan gum and derivatives thereof, guar gum and derivatives thereof, tragacanth gum and derivatives thereof, polyacrylates and derivatives thereof, agarose, casein, starch, poly(vinylidene difluoride), poly[1-(2-oxo-1-pyrrolidinyl)ethylene], polytetrafluoroethylene, n-methyl-2-pyrrolidone, polyvinylidene fluoride, and other natural polymers, gelatin, chitosan, alginate, other organic and inorganic binders, and mixtures thereof.

6. The sorbent composition of claim 1, wherein the sorbent composition is used to treat a contaminated water medium, wherein the contaminant comprises PFOS and/or PFOA wherein the contaminated water medium has up to about 500,000 ppt concentration of a target contaminant, and wherein the sorbent can entrap the target contaminant to reach a contaminant concentration of no more than about 4 ppt.

7. The sorbent composition of claim 1, wherein a total pore volume of the free-flowing particulates of the sorbent composition is at least about 0.60 cc/g, and wherein at least about 70% of the pores have a pore size of no more than about 500 Å.

8. The sorbent composition of claim 1, wherein the sorbent composition comprises a micropore volume, for pores having a pore size of no more than about 20 Å, is at least about 0.40 cc/g, wherein the sorbent composition comprises transport pores, wherein the transport pores have a pore size of about 2 times to about 10 times the molecular diameter of the target contaminant, and wherein the sorbent composition comprises a transport pore volume of at least about 0.10 cc/g.

9. The sorbent composition of claim 1, wherein the sorbent composition comprises a small mesopore pore volume of at least about 0.15 cc/g, wherein the small mesopores have a pore size from about 20 Å to about 150 Å and wherein the sorbent composition further comprises sequestration pores, wherein the sequestration pores have a pore size of about 1 to about 2 times the diameter of a target contaminant, and wherein the sorbent composition further comprises a volume of at least about 0.20 cc/g of sequestration pores.

10. The sorbent composition of claim 1, wherein the sorbent composition comprises sequestration pores, wherein the sequestration pores have a pore size of about 1 to about 2 times the molecular diameter of a target contaminant, and wherein the sorbent composition further comprises a volume of at least about 0.20 cc/g of sequestration pores, wherein the sorbent comprises transport pores, wherein the transport pores have a pore size of about 2 times to about 10 times the molecular diameter of the target contaminant, and wherein the sorbent composition comprises a transport pore volume of at least about 0.10 cc/g.

11. The sorbent composition of claim 1, wherein the sorbent composition has an iodine number ranging from about 980 to about 1100 mg/g, an apparent density of at least about 0.35 g/cc, wherein the sorbent composition comprises small mesopores, wherein the small mesopores have a pore size ranging from about 20 Å to about 150 Å, wherein the volume of small mesopores is at least about 0.15 cc/g, and wherein the small mesopores are used for transport of at least one contaminant.

12. The sorbent composition of claim 1, wherein the sorbent composition comprises micropores, wherein the micropores have a pore size less than about 20 Å, wherein the sorbent composition comprises from about 15 to about 25 vol % micropores, wherein the sorbent composition further comprises small mesopores, wherein the small mesopores have a pore size ranging from about 20 Å to about 150 Å, wherein the sorbent composition comprises from about at least 5 vol % to about 10 vol % small mesopores, wherein the sorbent composition comprises large mesopores and macropores, wherein the large mesopores have a pore size ranging from about 150 Å to about 500 Å and the macropores have a pore size ranging from about 500 Å to about 1,000 Å, wherein the sorbent composition comprises about 3 to about 6 vol % large mesopores and macropores, wherein the sorbent composition further comprises about 18 to about 30 vol % of solid activated carbon, wherein the sorbent composition comprises void space, and wherein the sorbent composition comprises about 40 to about 55 vol % of the void space.

13. A method comprising treating a contaminated medium with a sorbent composition comprising greater than about 90 wt % bituminous coal, less than about 0.5 wt % green strength binder, and less than about 2 wt % moisture, wherein the sorbent composition comprises sequestration pores, wherein the sequestration pores have a pore size of about 1 to about 2 times the molecular diameter of a target contaminant, wherein the sorbent composition has an apparent density of at least about 0.30 g/cc, and wherein the sequestration pore volume is at least about 0.15 cc/g.

14. The method of claim 13, wherein the sorbent composition comprises primarily activated carbon, at least most of the particulates of the sorbent composition having a mean and/or median sphericity in the range of from about 0.75 to about 1.0, a total pore volume ranging from about 0.50 to about 0.90 cc/g for pores having a pore size of no more than about 1,000 Å, a BET surface area of at least about 900 m²/g, wherein the sorbent composition is derived from a carbonaceous feed material comprising bituminous coal, a green strength binder, and an activation binder, and wherein the carbonaceous feed material comprises at least about 70 wt % bituminous coal on a dry weight basis.

15. The method of claim 13, wherein the contaminated medium is water, wherein the water comprises per- and poly-fluoroalkyl substances, wherein the per- and poly-fluoroalkyl substances are present in the water at a concentration of at least about maximum contaminant level up to about 500,000 ppt and wherein the sorbent can entrap the target contaminant to decrease the contaminant concentration to no more than about 4 ppt PFOS and/or PFOA.

16. The method of claim 13, wherein the sorbent composition comprises micropores, wherein the micropores have a pore size less than about 20 Å, wherein the sorbent composition comprises from about 15 to about 25 vol % micropores, wherein the sorbent composition further comprises small mesopores, wherein the small mesopores have a pore size ranging from about 20 Å to about 150 Å, wherein the sorbent composition comprises from at least about 5 to about 10 vol % small mesopores, wherein the sorbent composition comprises large mesopores and macropores, wherein the large mesopores have a pore size ranging from about 150 Å to about 500 Å and the macropores have a pore size ranging from about 500 Å to about 1,000 Å, wherein the sorbent composition comprises about 3 to about 6 vol % large mesopores and macropores, wherein the sorbent composition further comprises about 18 to about 30 vol % of solid activated carbon, wherein the sorbent composition comprises void space, and wherein the sorbent composition comprises about 40 to about 55 vol % of the void space, wherein the small mesopores transport the at least one contaminants, and wherein the micropores sequester the at least one contaminant.

17. The method of claim 13, wherein the sorbent composition has small mesopores, wherein the small mesopores have a pore size from about 20 Å to about 150 Å, wherein the sorbent composition comprises at least about 0.15 cc/g small mesopores, wherein the sorbent composition comprises micropores, wherein the micropores have a pore size no more than about 20 Å, wherein the sorbent composition comprises at least about 0.30 cc/g micropores, and wherein the micropores entrap contaminants from the contaminated medium.

18. The method of claim 13, wherein the contaminated mediums comprise municipal water, groundwater, soils, and sediments, wherein the at least one contaminant comprises per- and poly-fluoroalkyl molecules at a concentration level ranging from about the maximum contaminant level to about 500,000 ppt, and wherein the sorbent removes the contaminant to a level of no more than about 4 ppt PFOA and/or PFOS after treatment with the sorbent.

19. The method of claim 13, wherein the sorbent composition comprises pores, wherein the pores have a pore size no more than about 1,000 Å, wherein the sorbent composition comprises a total pore volume at least about 0.60 cc/g, wherein the sorbent composition has an iodine number of about 980 to about 1100 mg/g, wherein the sorbent composition comprises sequestration pores, wherein the sequestration pores have a pore size about 1 to about 2 times the molecular diameter of the target contaminant, wherein the sorbent composition comprises at least about 0.20 cc/g sequestration pores, wherein the sorbent composition comprises small mesopores, and wherein the small mesopores have a pore size from about 20 Å to about 150 Å, wherein the sorbent composition has a volume of at least about 0.10 cc/g small mesopores.

20. The method of claim 13, wherein the contaminated medium comprises water, wherein the at least one contaminant comprises per- and poly-fluoroalkyl substances at a concentration level ranging from about the maximum contaminant level to about 500,000 ppt, and wherein the sorbent removes the contaminant to a level of no more than about 4 ppt of at least one of PFOA and PFOS after treatment with the sorbent, wherein the sorbent composition comprises sequestration pores, about 1 to about 2 times the molecular diameter of the target contaminant, wherein the sorbent composition comprises at least about 0.20 cc/g volume of sequestration pores, wherein the sorbent composition comprises transport pores, wherein the transport pores have a pore size from about 2 to about 10 times the molecular diameter of the target contaminant, and wherein the sorbent composition comprises a transport pore volume of at least about 0.15 cc/g.
